(19) United States
(12) Patent Application Publication
(10) Pub. No.: US 2026/0067726 A1
(43) Pub. Date: Mar. 5, 2026

(54) AI NATIVE MOBILITY MEASUREMENT PARAMETERS SELECTION

(71) Applicant: QUALCOMM Incorporated, San Diego, CA (US)

(72) Inventors: Mickael MONDET, Louannec (FR); Prasada Veera Reddy KADIRI, San Diego, CA (US); Diana MAAMARI, San Diego, CA (US)

(21) Appl. No.: 18/820,151

(22) Filed: Aug. 29, 2024

(51) Int. Cl. H04W 24/10; H04W 36/00

(52) U.S. Cl. CPC H04W 24/10; H04W 36/0058

(57) ABSTRACT

AI native mobility measurement parameters selection is described. An apparatus is configured to obtain a set of mobility measurements associated with a set of network nodes. The set of network nodes includes a serving cell and at least one neighboring cell. The apparatus is configured to select a set of mobility measurement parameters, associated with a set of mobility parameter ranges, in accordance with an AI/ML model and based on at least one of the set of mobility measurements or a set of measurement configurations indicative of at least one of a set of mobility measurement parameter candidates or the set of mobility parameter ranges. The apparatus is configured to transmit, to the serving cell and at a time in accordance with the AI/ML model, a selected value report indicative of a set of mobility measurement values associated with the set of mobility measurement parameters.

### TECHNICAL FIELD

The present disclosure relates generally to communication systems, and more particularly, to wireless communications utilizing mobility measurements.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be, or may comprise, a user equipment (UE), and the method may be performed at, or by, the UE. The apparatus is configured to obtain a set of mobility measurements associated with a set of network nodes, where the set of network nodes includes a serving cell and at least one neighboring cell. The apparatus is configured to select a set of mobility measurement parameters, associated with a set of mobility parameter ranges, in accordance with an artificial intelligence (AI)/machine learning (ML) model and based on at least one of the set of mobility measurements or a set of measurement configurations indicative of at least one of a set of mobility measurement parameter candidates or the set of mobility parameter ranges. The apparatus is configured to transmit, to the serving cell and at a time in accordance with the AI/ML model, a selected value report indicative of a set of mobility measurement values associated with the set of mobility measurement parameters.

In the aspect, the method includes obtaining a set of mobility measurements associated with a set of network nodes, where the set of network nodes includes a serving cell and at least one neighboring cell. The method includes selecting a set of mobility measurement parameters, associated with a set of mobility parameter ranges, in accordance with an artificial intelligence AI/ML model and based on at least one of the set of mobility measurements or a set of measurement configurations indicative of at least one of a set of mobility measurement parameter candidates or the set of mobility parameter ranges. The method includes transmitting, to the serving cell and at a time in accordance with the AI/ML model, a selected value report indicative of a set of mobility measurement values associated with the set of mobility measurement parameters.

In another aspect of the disclosure, a method, a computer-readable medium, and an apparatus are provided. The apparatus is configured to transmit, for a UE, a set of measurement configurations indicative of at least one of a set of mobility measurement parameter candidates or a set of mobility parameter ranges. The apparatus is configured to receive, from the UE and at a time in accordance with an AI/ML model associated with mobility measurements, a selected value report indicative of a set of mobility measurement values associated with a set of mobility measurement parameters.

In the aspect, the method includes transmitting, for a UE, a set of measurement configurations indicative of at least one of a set of mobility measurement parameter candidates or a set of mobility parameter ranges. The method includes receiving, from the UE and at a time in accordance with an artificial intelligence AI/ML model associated with mobility measurements, a selected value report indicative of a set of mobility measurement values associated with a set of mobility measurement parameters.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating example extended reality (XR) traffic.

FIG. 5 is a call flow diagram for wireless communications, in accordance with various aspects of the present disclosure.

FIG. 6 is a diagram illustrating example measurement configurations and UE capabilities for AI native mobility measurement parameters selection, in accordance with various aspects of the present disclosure.

FIG. 7 is a diagram illustrating example measurement configurations and reports for AI native mobility measurement parameters selection, in accordance with various aspects of the present disclosure.

FIG. 8 is a diagram illustrating example mobility measurements and reporting selection in a measurement environment for AI native mobility measurement parameters selection, in accordance with various aspects of the present disclosure.

FIG. 9 is a diagram illustrating example information elements (IEs) for AI native mobility measurement parameters selection, in accordance with various aspects of the present disclosure.

FIG. 10 is a diagram illustrating example IEs for AI native mobility measurement parameters selection, in accordance with various aspects of the present disclosure.

FIG. 11 is a flowchart of a method of wireless communication.

FIG. 12 is a flowchart of a method of wireless communication.

FIG. 13 is a flowchart of a method of wireless communication.

FIG. 14 is a flowchart of a method of wireless communication.

FIG. 15 is a diagram illustrating an example of a hardware implementation for an example apparatus and/or network entity.

FIG. 16 is a diagram illustrating an example of a hardware implementation for an example network entity.

### DETAILED DESCRIPTION

Wireless communication networks may be designed to support communications between network entities (e.g., network nodes such as base stations, eNBs, gNBs, etc.; entities in a core network), UEs, and/or XR devices. UEs may be, may comprise, and/or may be paired with XR devices to provide user experiences through XR. Wireless communication networks, such as 5G NR, provide a high-speed, low-latency and high-reliability wireless connectivity which can enable latency-sensitive services like the immersive XR multimedia and cloud computing (e.g., AR Glasses, a VR head-mounted display (HMD), cloud gaming, cloud AI, etc.). These advanced applications may have high levels for operational/system performance parameters to maintain the user experience, including but without limitation, data rate, latency, power consumption, and/or the like. As an example, to maintain low-latency and high-reliability, for an XR user experience, approximately 99% of packets for XR traffic should be delivered within a stipulated packet delay budget (PDB) (e.g., 10 ms).

However, handover is a challenging issue for latency-sensitive services like XR, as it can increase the interruption times and latencies. The reception of selected value reports at the wireless network by a network node (e.g., by a base station, gNB, etc.) triggers the handover procedure, and thus, the configuration of these measurements and selected value reports is very impactful in maintaining a good user experience. A UE can be configured with mobility measurements on neighboring cells, and for each measurement configuration, the selected value report can be event triggered. In some cases, selected value reports may be controlled by radio resource control (RRC) signaling parameters. Yet, the parameter settings impact the performance of the handover procedures. For instance, if the parameter settings are incorrectly set, the selected value report may not be transmitted at the right time. As one example, if the selected value report is sent too late, the selected value report may not be received by the network node, or the handover command may not be received by the UE, because the radio conditions worsened (e.g., resulting in radio link failure). As another example, if the selected value report is sent too early, the UE may be moved to the target cell too early, and the user experience may have been better had the UE stayed longer in the source cell, or even less desirably, the UE may not be able to connect to the target cell (e.g., resulting in handover failure). Current solutions for parameter settings and triggering selected value reports via semi-static settings lack robustness to accommodate radio-related situations for UEs, and may negatively impact the user experience for XR applications.

Various aspects relate generally to wireless communications utilizing mobility measurements. Some aspects more specifically relate to AI native mobility measurement parameters selection. In some examples, a UE may perform mobility measurement parameter selection(s) based on an AI/ML model within a configuration range allowed by the network. In some examples, the network node may configure the UE for parameters, ranges, overrides, and/or reporting of values. In some examples, the network node may dynamically update parameter values for the UE. In some examples, the UE may be configured for, and performs, data collection and reporting, such as for each measurement configuration. In some examples, the UE may fall back to network configured values based on performance.

Particular aspects of the subject matter described in this disclosure can be implemented to realize one or more of the following potential advantages. In some examples, by enabling AI/ML selection/triggers of selected parameter values for reporting of measurements, the described techniques can be used to accommodate timing of radio-related situations for UEs to prevent radio link failure and handover failure. In some examples, by enabling UE data collection and report of data and measurement values, the described techniques can be used to refine and improve parameter value selection and implementation in wireless networks. In some examples, by enabling UE overrides of configured parameter values and value recommendations, the described techniques can be used to improve parameter value selection and implementation based on a UE perspective.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

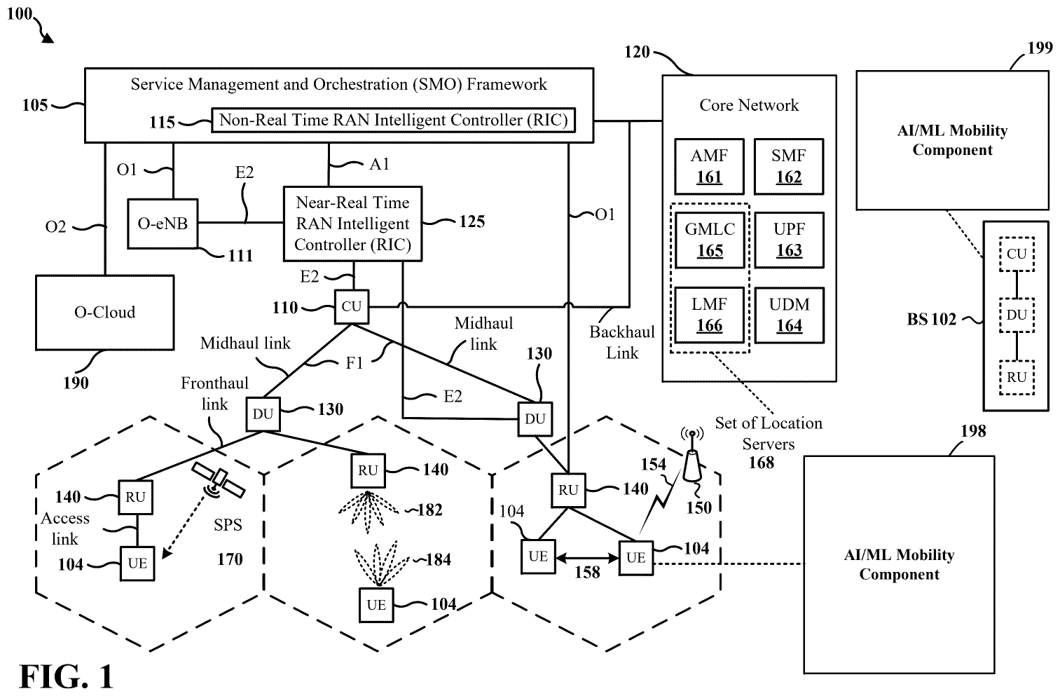

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUs 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via 01) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHZ, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have an AI/ML mobility component 198 (“component 198”) that may be configured to obtain a set of mobility measurements associated with a set of network nodes, where the set of network nodes includes a serving cell and at least one neighboring cell. The component 198 may be configured to select a set of mobility measurement parameters, associated with a set of mobility parameter ranges, in accordance with an AI/ML model and based on at least one of the set of mobility measurements or a set of measurement configurations indicative of at least one of a set of mobility measurement parameter candidates or the set of mobility parameter ranges. The component 198 may be configured to transmit, to the serving cell and at a time in accordance with the AI/ML model, a selected value report indicative of a set of mobility measurement values associated with the set of mobility measurement parameters. In certain aspects, the base station 102 may have an AI/ML mobility component 199 (“component 199”) that may be configured to transmit, for a UE, a set of measurement configurations indicative of at least one of a set of mobility measurement parameter candidates or a set of mobility parameter ranges. The component 199 may be configured to receive, from the UE and at a time in accordance with an AI/ML model associated with mobility measurements, a selected value report indicative of a set of mobility measurement values associated with a set of mobility measurement parameters. Accordingly, aspects herein for AI native mobility measurement parameters selection improve the quality of a user experience in XR through increased robustness for radio-related situations for UEs, and enable a UE to perform mobility measurement parameter selection(s) based on an AI/ML model within a configuration range allowed by the network, enable a network node to configure the UE for parameters, ranges, overrides, and/or reporting of values, and enable the network node to dynamically update parameter values for the UE. Aspects provide for UE configurations for data collection and reporting, such as for each measurement configuration, and for UE fallback to network configured values based on performance. Aspects accommodate timing of radio-related situations for UEs to prevent radio link failure and handover failure by enabling AI/ML selection/triggers of selected value reporting parameter values, refine and improve parameter value selection and implementation in wireless networks by enabling UE data collection and report of data and measurement values, and also improve parameter value selection and implementation based on a UE perspective by enabling UE overrides of configured parameter values and value recommendations.

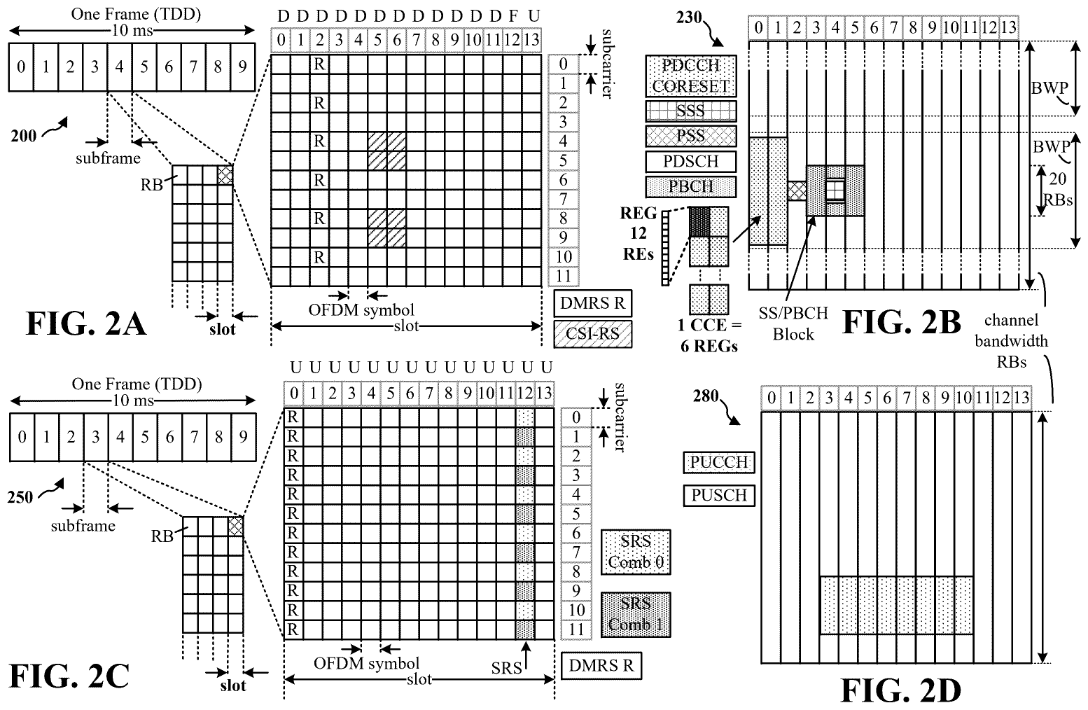

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

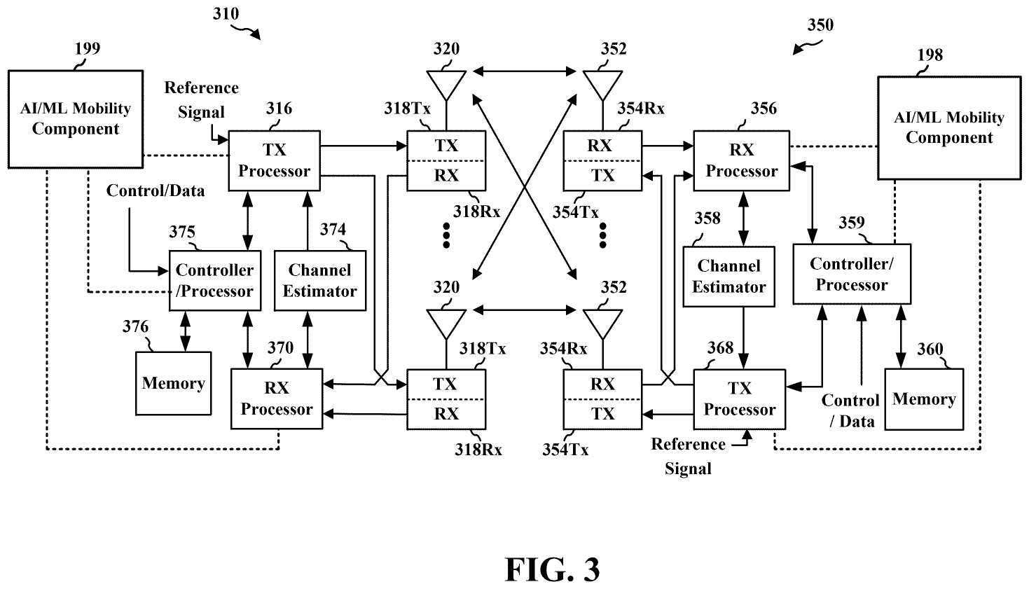

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization. The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the component 198 of FIG. 1.

At least one of the TX processor 316, the RX processor 370, and the controller/processor 375 may be configured to perform aspects in connection with the component 199 of FIG. 1.

UEs may be, may comprise, and/or may be paired with XR devices to provide user experiences through XR. Wireless communication networks, such as 5G NR, provide a high-speed, low-latency and high-reliability wireless connectivity which can enable latency-sensitive services like the immersive XR multimedia and cloud computing (e.g., AR Glasses, a VR HMD, cloud gaming, cloud AI, etc.). These advanced applications may have high levels for operational/system performance parameters to maintain the user experience, including but without limitation, data rate, latency, power consumption, and/or the like. As an example, to maintain low-latency and high-reliability, for an XR user experience, approximately 99% of packets for XR traffic should be delivered within a stipulated PDB (e.g., 10 ms). However, handover is a challenging issue for latency-sensitive services like XR, as it can increase the interruption times and latencies. The reception of selected value reports at the wireless network by a network node (e.g., by a base station, gNB, etc.) triggers the handover procedure, and thus, the configuration of these measurements and selected value reports is very impactful in maintaining a good user experience. A UE can be configured with mobility measurements on neighboring cells, and for each measurement configuration, the selected value report can be event triggered. In some cases, selected value reports may be controlled by RRC signaling parameters. Yet, the parameter settings impact the performance of the handover procedures. For instance, if the parameter settings are incorrectly set, the selected value report may not be transmitted at the right time. As one example, if the selected value report is sent too late, the selected value report may not be received by the network node, or the handover command may not be received by the UE, because the radio conditions worsened (e.g., resulting in radio link failure). As another example, if the selected value report is sent too early, the UE may be moved to the target cell too early, and the user experience may have been better had the UE stayed longer in the source cell, or even less desirably, the UE may not be able to connect to the target cell (e.g., resulting in handover failure). As examples, offset parameters may result in a selected value report being sent too early due to a low value, or a selected value report being sent too late due to a high value. Hysteresis parameters may result in trigger and cancelation conditions being set too early due to a low value, or in trigger and cancelation conditions being set too late due to a high value. Time to trigger parameters may result in a selected value report being sent too early due to a low value, or a selected value report being sent too late due to a high value.

Current solutions for parameter settings and triggering selected value reports via semi-static settings lack robustness to accommodate radio-related situations for UEs, and may negatively impact the user experience for XR applications.

As noted above, a UE can be configured with mobility measurements on neighboring cells, and for each measurement configuration, the selected value report can be event triggered. Table 2 shows examples of selected value report event triggers.

TABLE 2
Selected Value Report Event Triggers

| Event | Description | Use Case |
|---|---|---|
| A1 | Serving becomes better | To cancel an ongoing handover, |
| | than threshold | which has not started yet |
| A2 | Serving becomes worse | To trigger a handover when a UE |
| | than threshold | moves towards cell edge (e.g., |
| | | blind HO) |
| A3 | Neighbor becomes offset | For intra-frequency or inter-frequency |
| | better than SpCell | handover. |
| A4 | Neighbor becomes better | For handovers which do not depend |
| | than threshold | upon the coverage of the serving |
| | | cell (e.g., load balancing) |
| A5 | SpCell becomes worse | For intra-frequency or inter-frequency |
| | than threshold1 AND | handover (can be seen as combination |
| | Neighbor becomes better | of A2 and A4) |
| | than threshold2 | |
| A6 | Neighbor becomes offset | For Carrier Aggregation (e.g., Scell |
| | better than SCell | Addition/Change) |
| B1 | Inter RAT neighbor | For inter-RAT handover which does not |
| | becomes better than | depend upon the coverage of the serving |
| | threshold | cell (e.g., load balancing) |
| B2 | PCell becomes worse | To trigger inter-RAT mobility handover |
| | than threshold1 AND | when the primary serving cell becomes |
| | Inter RAT neighbor | weak |
| | becomes better than | |
| | threshold2 | |

Additionally, selected value reports may be controlled by RRC signaling parameters, as shown in Table 3.

TABLE 3
Selected Value Report RRC Parameters

| Event | Description | RRC Parameters |
|---|---|---|
| A1 | Serving becomes better | Threshold, Hysteresis, Time To |
| | than threshold | Trigger |
| A2 | Serving becomes worse | Threshold, Hysteresis, Time To |
| | than threshold | Trigger |
| A3 | Neighbor becomes offset | Measurement Offset, Neighbor Cell |
| | better than SpCell | Offset, Serving Cell Offset |
| | | Hysteresis, Event Offset; Time To |
| | | Trigger |
| A4 | Neighbor becomes better | Measurement Offset, Neighbor Cell |
| | than threshold | Offset |
| | | Threshold, Hysteresis, Time To |
| | | Trigger |
| A5 | SpCell becomes worse | Measurement Offset, Neighbor Cell |
| | than threshold1 AND | Offset, Serving Cell Threshold, |
| | Neighbor becomes better | Neighbor Cell Threshold, |
| | than threshold2 | Hysteresis, Time To Trigger |
| A6 | Neighbor becomes offset | Neighbor Cell Offset, Serving Cell |
| | better than SCell | Offset, Event Offset |
| | | Hysteresis, Time To Trigger |
| B1 | Inter RAT neighbor | Measurement Offset, Neighbor Cell |
| | becomes better than | Offset |
| | threshold | Threshold, Hysteresis, Time To |
| | | Trigger |
| B2 | PCell becomes worse | Measurement Offset, Neighbor Cell |
| | than threshold1 AND | Offset, Serving Cell Threshold, |
| | Inter RAT neighbor | Neighbor Cell Threshold, |
| | becomes better than | Hysteresis, Time To Trigger |
| | threshold2 | |

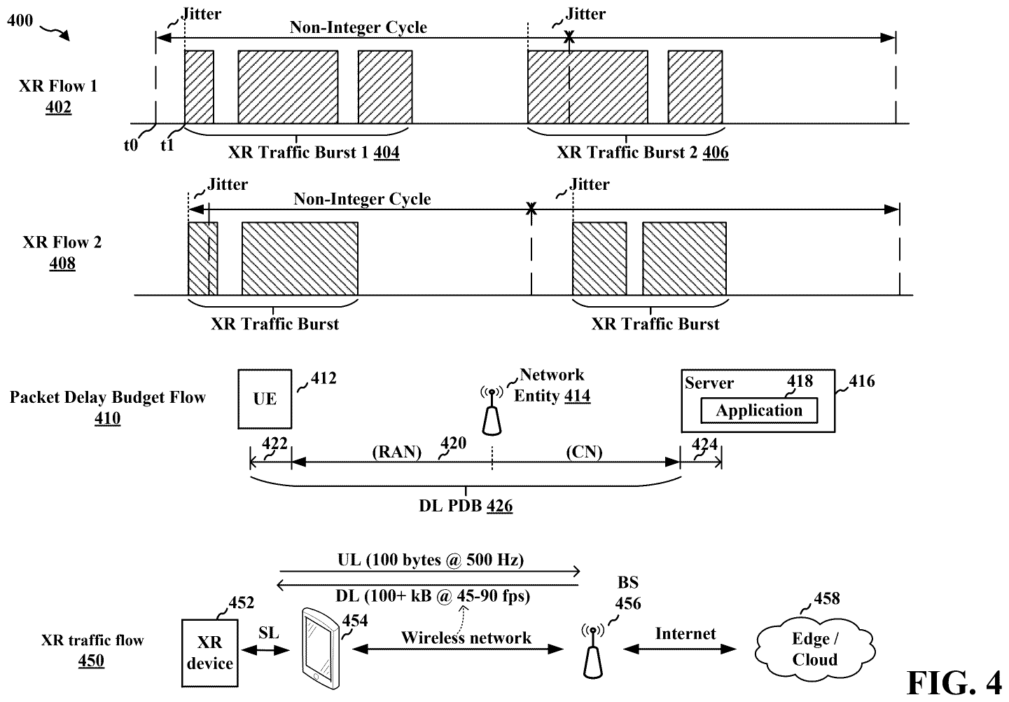

FIG. 4 is a diagram 400 illustrating example XR traffic. XR traffic may refer to wireless communications for technologies such as virtual reality (VR), mixed reality (MR), and/or augmented reality (AR). VR may refer to technologies in which a user is immersed in a simulated experience that is similar or different from the real world. A user may interact with a VR system through a VR headset, a multi-projected environment that generates realistic images, sounds, and other sensations that simulate a user's physical presence in a virtual environment, and/or the like. MR may refer to technologies in which aspects of a virtual environment and a real environment are mixed. AR may refer to technologies in which objects residing in the real world are enhanced via computer-generated perceptual information, sometimes across multiple sensory modalities, such as visual, auditory, haptic, somatosensory, and/or olfactory. An AR system may incorporate a combination of real and virtual worlds, real-time interaction, and accurate three-dimensional registration of virtual objects and real objects. In an example, an AR system may overlay sensory information (e.g., images) onto a natural environment and/or mask real objects from the natural environment. XR traffic may include video data and/or audio data. XR traffic may be transmitted by a base station and received by a UE or the XR traffic may be transmitted by a UE and received by a base station.

XR traffic may arrive in periodic traffic bursts (“XR traffic bursts”). An XR traffic burst may vary in a number of packets per burst and/or a size of each pack in the burst. The diagram 400 illustrates a first XR flow 402 that includes a first XR traffic burst 404 and a second XR traffic burst 406. As illustrated in the diagram 400, the traffic bursts may include different numbers of packets, e.g., the first XR traffic burst 404 being shown with three packets (represented as rectangles in the diagram 400) and the second XR traffic burst 406 being shown with two packets. Furthermore, as illustrated in the diagram 400, the three packets in the first XR traffic burst 404 and the two packets in the second XR traffic burst 406 may vary in size, that is, packets within the first XR traffic burst 404 and the second XR traffic burst 406 may include varying amounts of data.

XR traffic bursts may arrive at non-integer periods (i.e., in a non-integer cycle). The periods may be different than an integer number of symbols, slots, etc. In an example, for 60 frames per second (FPS or fps) video data, XR traffic bursts may arrive in 1/60=16.67 ms periods. In another example, for 120 FPS video data, XR traffic bursts may arrive in 1/120=8.33 ms periods.

Arrival times of XR traffic may vary. For example, XR traffic bursts may arrive and be available for transmission at a time that is earlier or later than a time at which a UE (or a base station) expects the XR traffic bursts. The variability of the packet arrival relative to the period (e.g., 16.76 ms period, 8.33 ms period, etc.) may be referred to as “jitter.” In an example, jitter for XR traffic may range from −4 ms (earlier than expected arrival) to +4 ms (later than expected arrival). For instance, referring to the first XR flow 402, a UE may expect a first packet of the first XR traffic burst 404 to arrive at time to, but the first packet of the first XR traffic burst 404 arrives at a time t1, as shown.

XR traffic may include multiple flows that arrive at a UE (or a base station) concurrently with one another (or within a threshold period of time). For instance, the diagram 400 includes a second XR flow 408. The second XR flow 408 may have different characteristics than the first XR flow 402. For instance, the second XR flow 408 may have XR traffic bursts with different numbers of packets, different sizes of packets, etc. In an example, the first XR flow 402 may include video data and the second XR flow 408 may include audio data for the video data. In another example, the first XR flow 402 may include intra-coded picture frames (I-frames) that include complete images and the second XR flow 408 may include predicted picture frames (P-frames) that include changes from a previous image.

An XR traffic overall PDB may include a portion to allow for communication delay of data (e2e PDB) between a UE and a computing device, e.g., a server, hosting an application, e.g., for XR, and a portion for additional time after the communication delay before the data is discarded, e.g., residual delay (e.g., PDB). For instance, the diagram 400 includes a packet delay budget flow 410. Packet delay budget flow 410 illustrates a UE 412, a network entity 414 (e.g., a base station or portion thereof), and a server 416 that hosts an application 418. In the illustrated aspect, a communication delay 420 is shown as including a RAN portion between the UE 412 and the network entity 414, as well as a CN portion between the network entity 414 and the server 416. The communication delay 420 may apply to both UL and DL communications. Additionally, a residual delay 422 is shown at the UE 412 for DL communications and a residual delay 424 is shown at the server 416 for UL communications. The communication delay 420 and the residual delay 422 may make up an overall PDB for DL XR communications, e.g., DL PDB 426. Likewise, the communication delay 420 and the residual delay 424 may make up an overall PDB for UL XR communications (not shown for illustrative clarity).

In general, XR traffic may be characterized by relatively high data rates and low latency. The latency in XR traffic may affect the user experience. For instance, XR traffic may have applications in eMBB and URLLC services.

An example of an XR traffic flow 450 is also shown in the context of an XR implementation between an XR device 452 (e.g., a SL Rx UE) and a companion UE 454 (e.g., a smartphone as a SL Tx UE), where the companion UE 454 communicates over a wireless network with a network node (e.g., a base station 456, a gNB, etc.). The wireless network may provide UL connections at 100 bytes (500 Hz) and DL connections at over 100 KB (45 fps to 90 fps). The base station 456 may communicate with an edge/cloud server 458 that hosts an XR application with which the XR device 452 may be associated.

Aspects provide for the AI/ML version of legacy selected value reporting where the UE can be allowed to change some of the parameters. Instead of a specific value, the network configures a value range for each of the event parameters. Within this range, the UE can autonomously determine on when to send the selected value report. This is supposed to be better since the UE may have more insight on what is going on. There are some variations, e.g., the UE can override parameter value configurations, and/or the UE reports at which value of a parameter the selected value report was sent. The network might alternatively provide a table of parameter values via RRC and then dynamically indicate via MAC-CE or DCI which of the values in the table to select. UE selected parameter values can be collected. UE can report all of this in capabilities. The UE may use AI/ML to select the parameter within the range. In order to provide the best possible user experience, triggering selected value reports at the right time, neither too soon, nor too late, is very important.

Aspects herein for AI native mobility measurement parameters selection improve the quality of a user experience in XR through increased robustness for radio-related situations for UEs. Aspects enable a UE to perform mobility measurement parameter selection(s) based on an AI/ML model within a configuration range allowed by the network, enable a network node to configure the UE for parameters, ranges, overrides, and/or reporting of values, and enable the network node to dynamically update parameter values for the UE. Aspects provide for UE configurations for data collection and reporting, such as for each measurement configuration, and for UE fallback to network configured values based on performance. Aspects accommodate timing of radio-related situations for UEs to prevent radio link failure and handover failure by enabling AI/ML selection/triggers of selected value reporting parameter values. Aspects refine and improve parameter value selection and implementation in wireless networks by enabling UE data collection and report of data and measurement values. Aspects also improve parameter value selection and implementation based on a UE perspective by enabling UE overrides of configured selected parameter values and value recommendations. Aspects herein may be described in the context of 5G NR for brevity and ease of illustration, but aspects are not so limited and are applicable to other wireless communication systems such as 6G wireless systems.

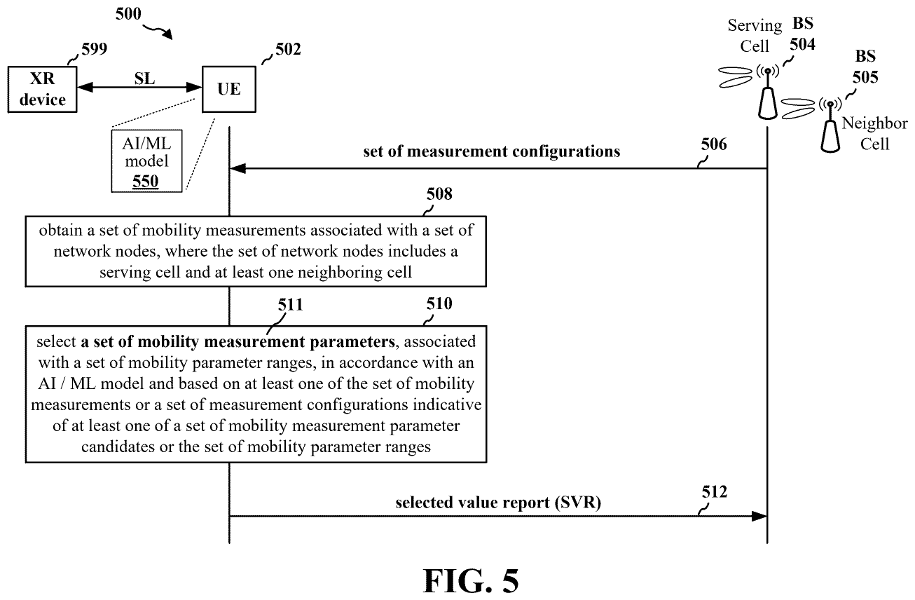

FIG. 5 is a call flow diagram 500 for wireless communications, in various aspects. Call flow diagram 500 illustrates AI native mobility measurement parameters selection for a UE (e.g., a UE 502), by way of example, that communicates with a network node (e.g., a base station 504 as a serving cell, a gNB, etc., as shown and described herein) and a neighbor network node (e.g., a base station 505 as a neighbor cell, a gNB, etc.), by way of example. The UE 502 may communicate via sidelink (SL) connections with an XR device 599 for utilization of XR applications, in aspects. While call flow diagram 500 is illustrated and described with respect to a base station, aspects include that the base station 504 may be two or more base stations. Aspects described for base stations, and for network nodes/entities herein, generally, may be performed in aggregated form and/or by one or more components in disaggregated form. Additionally, or alternatively, the aspects may be performed by a UE autonomously, in addition to, and/or in lieu of, operations of a network node/base station. In aspects, the UE 502 may comprise, execute, or otherwise employ an AI/ML model 550.

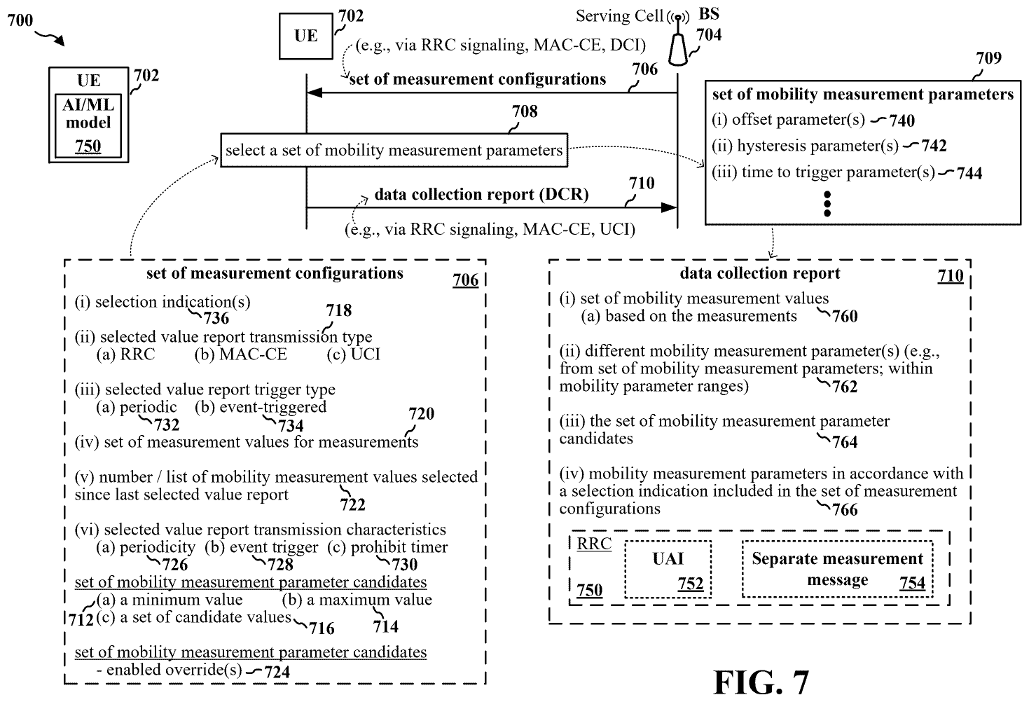

In the illustrated aspect, the UE 502 may be configured to receive, and the base station 504 may be configured to transmit/provide/configure, via at least one of first RRC signaling, a first medium access control (MAC) control element (MAC-CE), or first DCI, a set of measurement configurations 506 indicative of at least one of a set of mobility measurement parameters 511 or a set of mobility parameter ranges. The set of measurement configurations 506 may be indicative of at least one of a minimum value, a maximum value, or a set of candidate values for one or more of the set of mobility measurement parameters 511. The set of measurement configurations 506 may be indicative of at least one enabled override by the UE 502 for one or more of the set of mobility measurement parameters 511. The set of measurement configurations 506 may be indicative of transmission for the selected value report 512 via at least one of RRC signaling, a MAC-CE, or UCI. In such aspects, the RRC signaling may include at least one of UE assistance information (UAI) or a separate measurement message. In some aspects, the set of measurement configurations 506 may be indicative of the set of mobility measurement values for measurements. The set of measurement configurations 506 may be further indicative of a number and/or a list of mobility measurement values of the set of mobility measurement values that have been selected since a last selected value report and/or a last data collection report (e.g., a most recent instance of a transmission for the selected value report 512/a data collection report, as described for FIG. 7). The set of measurement configurations 506 may also be further indicative a transmission periodicity, a transmission event trigger, and/or a prohibit timer associated with the selected value report 512.

To receive the set of measurement configurations 506, the UE 502 may be configured to receive a set of dynamic measurement configuration updates associated with at least one of the set of mobility measurement parameters 511 or the set of mobility parameter ranges, which the base station 504 may be configured to transmit/provide/configure. In some aspects, to receive the set of dynamic measurement configuration updates, which the base station 504 may be configured to transmit/provide/configure, the UE 502 may be configured to receive, via second RRC signaling, a data structure indicative of a set of candidate mobility measurement values associated with at least one of the set of mobility measurement parameters 511 or the set of mobility parameter ranges. In some aspects, to receive the set of dynamic measurement configuration updates, which the base station 504 may be configured to transmit/provide/configure, the UE 502 may be configured to receive, via at least one of a second MAC-CE or second DCI, a set of data structure indices associated with the data structure indicative of the set of candidate mobility measurement values. In such aspects, the UE 502 may be configured to transmit/provide, and the base station 504 may be configured to receive, a HARQ-ACK based on reception of the set of data structure indices.

To receive the set of measurement configurations, the UE 502 may be configured to report (e.g., transmit/provide), and the base station 504 may be configured to receive, based on the set of measurement configurations 506, a capability indication indicative of at least one of (i) a parameter selection capability of the UE associated with mobility measurement parameters based on the AI/ML model 550 or (ii) a data collection capability of the UE associated with at least one of a number or a list of mobility measurement values of the set of mobility measurement values that have been selected since a last selected value report (e.g., a most recent instance of a transmission for the selected value report 512).

In aspects, the UE 502 may be configured to obtain (at 508) a set of mobility measurements associated with a set of network nodes. The set of network nodes may include a serving cell (e.g., a network node such as the base station 504, a gNB, etc.) and at least one neighboring cell (e.g., at least one network node such as the base station 505, a gNB, etc.). In aspects, the UE 502 may be configured with the set of mobility measurements associated with the set of network nodes by one or more of the set of network nodes.

The UE 502 may be configured to select (at 510) the set of mobility measurement parameters 511, associated with a set of mobility parameter ranges, in accordance with an artificial intelligence AI/ML model 550 and based on at least one of the set of mobility measurements or the set of measurement configurations 506 indicative of at least one of a set of mobility measurement parameter candidates or the set of mobility parameter ranges. In aspects, the UE 502 may be configured to select (at 510) at least one second mobility measurement parameter of the set of mobility measurement parameters 511 that is different from at least one of the set of mobility measurement parameter candidates (e.g., based on an override by the UE 502) or the set of mobility parameter ranges. In aspects, the UE 502 may be configured to select (at 510) the set of mobility measurement parameters 511 in accordance with the set of measurement configurations 506 indicative of at least one of the set of mobility measurement parameters 511 or the set of mobility parameter ranges. In aspects, the UE 502 may be configured to select (at 510) the set of mobility measurement parameters 511 in accordance with a selection indication included in the set of measurement configurations 506. In aspects, the UE 502 may be configured to select (at 510) the set of mobility measurement parameters 511 as including to measure the set of mobility measurement values in accordance with the set of measurement configurations 506 being indicative of the set of mobility measurement values for the measurements.

The UE 502 may be configured to transmit/provide, to the serving cell (e.g., the base station 504 which may be configured to receive), at a time in accordance with the AI/ML model 550, a selected value report (SVR) 512. The selected value report 512 may be indicative of a set of mobility measurement values associated with the set of mobility measurement parameters 511. In aspects, the UE 502 may be configured to transmit the selected value report 512 in accordance with the set of measurement configurations 506. The set of measurement configurations 506 may be indicative of at least one of periodic transmission or event triggered transmission of the selected value report 512. The UE 502 may be configured to transmit/provide the selected value report 512 based on a prohibit timer that is indicative of a time period during which the transmission of the selected value report is prohibited.

In aspects, the UE 502 may be configured to fall back to indications/settings/values of the set of measurement configurations 506, e.g., based on worsening performance associated with overrides/recommendations selected (e.g., at 510) for the set of mobility measurement parameters 511. The UE 502 may be configured to revert to a set of candidate mobility measurement values, associated with the serving cell (e.g., the base station 504), for the set of mobility measurement parameters 511 based on a radio link failure or a handover failure, in some aspects. In aspects, based on the reversion and/or the failure, a prohibit timer may be activated during which the UE 502 may not be allowed/enabled to use a set of mobility measurement parameters selected by the UE 502. Additionally, the UE 502 may be configured to reselect the set of mobility measurement parameters 511 in accordance with the AI/ML model 550 based on an expiration of a prohibit timer associated with a reversion to the set of candidate mobility measurement values, in some aspects.

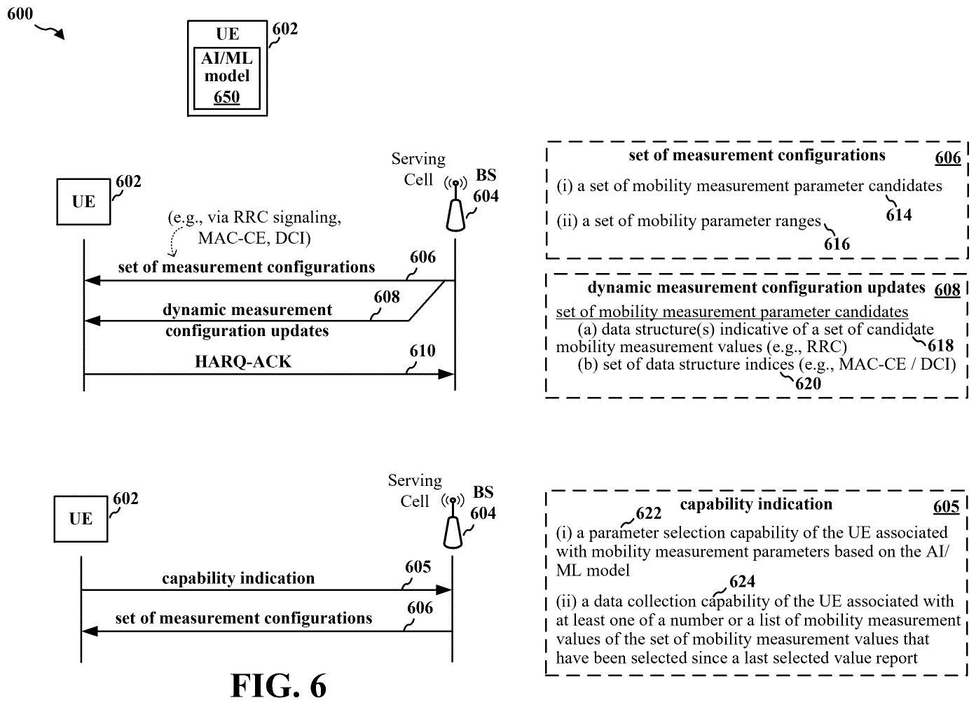

FIG. 6 is a diagram 600 illustrating example measurement configurations and UE capabilities for AI native mobility measurement parameters selection, in various aspects. Diagram 600 shows AI native mobility measurement parameters selection in association with a UE 602 (comprising, executing, or otherwise employing an AI/ML model 650) and a serving cell (e.g., a network node such as a base station 604, a gNB, etc.), and may be an aspect of the call flow diagram 500 in FIG. 5, as described above. According to aspects, the network (e.g., a serving cell such as the base station 604) may generally control/configure, at least in part, AI native mobility measurement parameters selection for UEs (e.g., the UE 602).

As similarly described herein, the UE 602 may be configured to receive, and the base station 604 may be configured to transmit/provide/configure, e.g., via first RRC signaling, a first MAC-CE, or first DCI, a set of measurement configurations 606 indicative of a set of mobility measurement parameter candidates 614 and/or a set of mobility parameter ranges 616. In some aspects, the UE 602 may not be configured to override values configured by the base station 604 with selected values, but the UE 602 may be configured to report the selection of a set of mobility measurement parameters, e.g., as a recommendation to the base station 604. In aspects, the base station 604 may utilize such a recommendation to update a value that the UE 602 (or other UEs) are using. In aspects, the set of measurement configurations 606 may be indicative of RRC reconfiguration procedures, as well as MAC-CE and DCI based configurations. That is, the base station 604 may be configured to update the value of any parameter of any measurement configuration dynamically. The UE 602 may be configured to receive a set of dynamic measurement configuration updates 608 associated with at least one of the set of mobility measurement parameter candidates 614 (e.g., each or less than all) or the set of mobility parameter ranges 616, which the base station 604 may be configured to transmit/provide/configure. In some aspects, to receive the set of dynamic measurement configuration updates, which the base station 604 may be configured to transmit/provide/configure, the UE 602 may be configured to receive, via second RRC signaling, a data structure 618 indicative of a set of candidate mobility measurement values associated with at least one of the set of mobility measurement parameter candidates 614 or the set of mobility parameter ranges 616. In some aspects, to receive the set of dynamic measurement configuration updates 608, which the base station 604 may be configured to transmit/provide/configure, the UE 602 may be configured to receive, via at least one of a second MAC-CE or second DCI, a set of data structure indices 620 associated with the data structure 618 indicative of the set of mobility measurement parameter candidates 614 values (e.g., the MAC-CE or the DCI may contain an index that points to the preconfigured table). The UE 602 may be preconfigured (e.g., RRC) with a data structure (e.g., a table) of possible values, in aspects. In some aspects, the UE 602 may be configured to transmit/provide, and the base station 604 may be configured to receive, a HARQ-ACK 610 based on reception of the set of data structure indices 620 for conformation of the reception.

In aspects, the UE 602 may be configured to report to the network (e.g., the base station 604 as a serving cell) whether the UE 602 is capable of performing mobility measurement parameters selection and data collection. In some aspects, as described herein, the UE 602 may be configured to report (e.g., transmit/provide; during a registration procedure), and the base station 604 may be configured to receive, a capability indication 605 indicative of at least one of (i) a parameter selection capability 622 of the UE 602 associated with mobility measurement parameters based on the AI/ML model 650 (e.g., parameters that the UE 602 is able to select based on an AI/ML mode 650) or (ii) a data collection capability 624 of the UE 602 associated with at least one of a number or a list of mobility measurement values of the set of mobility measurement values that have been selected since a last selected value report (e.g., the extent to which the UE 602 is capable to collect and report the data related to the selection). In aspects, the UE 602 may be configured to report indicia of capability in the capability indication 605 for each measurement configuration in the set of measurement configurations 606 to the base station 604. Subsequently, the base station 604 may configure the UE 602 with the set of measurement configurations 606, e.g., based at least in part on the capability indication 605.

FIG. 7 is a diagram 700 illustrating example measurement configurations and reports for AI native mobility measurement parameters selection, in various aspects. Diagram 700 shows AI native mobility measurement parameters selection in association with a UE 702 (comprising, executing, or otherwise employing an AI/ML model 750) and a serving cell (e.g., a network node such as a base station 704, a gNB, etc.), and may be an aspect of the call flow diagram 500 in FIG. 5, as described above.

According to aspects, the network (e.g., a serving cell such as the base station 704) may generally control/configure, at least in part, AI native mobility measurement parameters selection for UEs (e.g., the UE 702).

As similarly described herein, the UE 702 may be configured to receive, and the base station 704 may be configured to transmit/provide/configure, e.g., via first RRC signaling, a first MAC-CE, or first DCI, a set of measurement configurations 706 indicative of a set of mobility measurement parameter candidates 764 and/or a set of mobility parameter ranges. Subsequently, the UE 702 may be configured to select (at 708) a set of mobility measurement parameters 709, as similarly described herein (e.g., in accordance with a selection indication(s) 736 indicated in the set of measurement configurations 706), and to transmit/provide a data collection report 710 for reception by the base station 704. In aspects, for each measurement configuration the set of measurement configurations 706, the base station 704 may configure whether the UE 702 is to perform the mobility measurement parameter selection, e.g., via the selection indication(s) 736. The set of measurement configurations 706 may be indicative of a minimum value 712, a maximum value 714, and/or a set of candidate values 716 for one or more of the set of mobility measurement parameters 709. That is, for each parameter of the measurement configuration, the network may configure the boundaries of the selection by the UE. The set of measurement configurations 706 may be indicative of at least one enabled override 724 by the UE 702 for one or more of the set of mobility measurement parameters 709. That is, for each parameter of the measurement configuration, the network may configure whether the UE is allowed to override the value configured by the network (e.g., via existing RRC IEs) by the UE-selected value. The set of measurement configurations 706 may be indicative of transmission for the data collection report 710, e.g., a transmission type 718, via at least one of RRC signaling, a MAC-CE, or UCI. In such aspects, the RRC signaling may include at least one of UAI 752 or a separate measurement message 754. In some aspects, the set of measurement configurations 706 may be indicative of the set of mobility measurement values for measurements 720. The set of measurement configurations 706 may be further indicative of a number and/or a list of mobility measurement values 722 of the set of mobility measurement values that have been selected since a last data collection report (e.g., a most recent instance of a transmission for the data collection report 710 e.g., for data collection and reporting). The set of measurement configurations 706 may be indicative of at least one of periodic transmission 732 or event triggered transmission 734 of the selected value report 512 (in FIG. 5) and/or the data collection report 710. The set of measurement configurations 706 may also be further indicative a transmission periodicity 726, a transmission event trigger 728, and/or a prohibit timer 730 associated with the data collection report 710, e.g., for data collection and reporting. As an example, when the UE 702 selects a new value for any parameter of any measurement configuration, it can be beneficial to report this value to the base station 704. If the UE 702 is allowed/configured to override the value configured by the base station 704, the base station 704 may not be enabled to utilize the selected change, e.g., which value, the UE 702 has selected to use unless the base station 704 is informed of the change. Additionally, if the UE 702 is not allowed/configured to override the value(s) configured by the base station 704, the base station 704 may still utilize the reported value(s) as a recommendation(s), and may utilize any reported changes for a reconfiguration of the UE 702 and/or of other UEs.

In aspects, the set of mobility measurement parameters 709 selected (at 708) by the UE 702 may include a set of offset parameters 740, a set of hysteresis parameters 742, a set of time to trigger parameters 744, and/or the like. In aspects, ones of the set of mobility measurement parameters 709 may be associated with reference signals obtained from a set of network nodes (e.g., a serving cell, such as the base station 704) and at least one neighboring cell (e.g., another base station, gNB, etc.). The reference signals may include synchronization signal blocks (SSBs), CSI-RSs, and/or the like.

The UE 702 may be configured to transmit/provide, to the serving cell (e.g., the base station 704 which may be configured to receive), at a time in accordance with the AI/ML model 750, the data collection report 710. The data collection report 710 may be indicative of a set of mobility measurement values 760 associated with the set of mobility measurement parameters 709. In some aspects, the data collection report 710 may include a different mobility parameter(s) 762 than the mobility measurement parameters in the set of measurement configurations 706. The data collection report 710 may include the set of mobility measurement parameter candidates 764 and/or one or more mobility measurement parameters 766 in accordance with the selection indication 736.

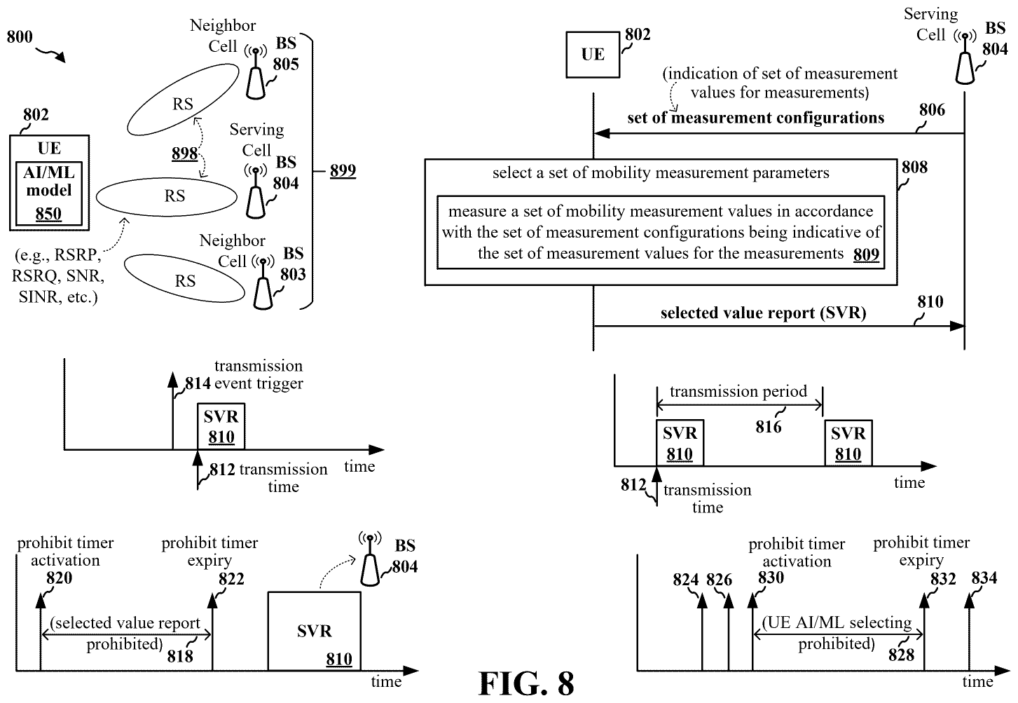

FIG. 8 is a diagram 800 illustrating example mobility measurements and reporting selection in a measurement environment for AI native mobility measurement parameters selection, in various aspects. Diagram 800 shows AI native mobility measurement parameters selection in association with a UE 802 (comprising, executing, or otherwise employing an AI/ML model 850) and a serving cell (e.g., a network node such as a base station 804, a gNB, etc.), and may be an aspect of the call flow diagram 500 in FIG. 5, as described above.

According to aspects, the network (e.g., a serving cell such as the base station 804) may generally control/configure, at least in part, AI native mobility measurement parameters selection for UEs (e.g., the UE 802). Diagram 800 shows a measurement environment for the UE 802 with the base station 804 (as the serving cell), as well as with a base station 803 and a base station 805 (as neighbor cells), comprising a set of network nodes 899. The UE 802 may receive reference signals 898 (e.g., SSBs, CSI-RSs, etc.) from the set of network nodes 899 on which mobility measurements may be performed by the UE 802 (e.g., based on RSRP, RSRQ, SNR, SINR, etc.), of the received reference signals 898.

For example, as similarly described herein, the UE 802 may be configured to receive, and the base station 804 may be configured to transmit/provide/configure, e.g., via first RRC signaling, a first MAC-CE, or first DCI, a set of measurement configurations 806 indicative of a set of mobility measurement parameter candidates and/or a set of mobility parameter ranges. In aspects, the set of measurement configurations 806 may include an indication of a set of mobility measurement values for measurements. As noted herein, the UE 802 may be configured to select (at 808) a set of mobility measurement parameters (e.g., in accordance with a selection indication(s) indicated in the set of measurement configurations 806), and to transmit/provide a selected value report 810 for reception by the base station 804. In aspects, to select (at 808) the set of mobility measurement parameters, the UE 802 may be configured to measure (at 809) a set of mobility measurement values in accordance with the set of measurement configurations 806 being indicative of the set of mobility measurement values for the measurements. In aspects, the measured set of mobility measurement values may be included in the selected value report 810.

As noted herein, selected value reports, such as the selected value report 810, may include information associated with a selection by a UE of a set of mobility measurement parameters and data collection for utilization by a serving cell of the UE, such as for building/training its own AI/ML model(s), application of data to UEs, and/or the like. In some aspects, the transmission of the selected value report 810 may be based on determinations made in association with the AI/ML model 850, e.g., a transmission time 812 at which the selected value report 810 is to be transmitted. In aspects, the UE 802 may also be configured with selected value report transmission conditions: a transmission even trigger 814 that indicates a selected value report should be transmitted (e.g., if the difference between a newly selected value and the latest value exceeds a configurable threshold), a periodicity 816 for transmission of the selected value report 810, a prohibit timer 818, having an activation 820 and an expiry 822, during which selected value reporting is prohibited (e.g., to prevent excessive numbers of the selected value report 810 being provided by the UE 802), and/or the like. The selected value report 810 may include/indicate a number of selected values that the UE 802 has selected (e.g., at 808) since the last instance of the selected value report 810 (e.g., having collected data provided therein). The selected value report 810 may include/indicate a list of values selected (at 808) by the UE 802 (e.g., the set of mobility measurement values for measurements).

In aspects, the UE 802 may be configured to fall back to indications/settings/values of the set of measurement configurations 806, e.g., based on worsening performance associated with overrides/recommendations selected (e.g., at 808) for the set of mobility measurement parameters (e.g., when selections made are not appropriate measurement parameter values). The UE 802 may be configured to revert (at 826) to a set of candidate mobility measurement values in the set of measurement configurations 806, associated with the serving cell (e.g., the base station 804), for the set of mobility measurement parameters based on a radio link/handover failure 824, in some aspects (e.g., if the UE 802 is experiencing a radio link failure because of bad radio quality (the T310 timer expires) or handover failure (due to T304 expiry), the UE 802 may fall back to the network configured values for all configured measurement events indicated by the set of measurement configurations 806). In some aspects, the reversion (at 826) may include a revert indication provided from the base station 804. The UE 802 may be configured to reselect (at 834) the set of mobility measurement parameters in accordance with the AI/ML model 850 based on an expiration 832 of a prohibit timer 828 (with an activation 830) associated with a reversion (at 826) to the set of candidate mobility measurement values, in some aspects.

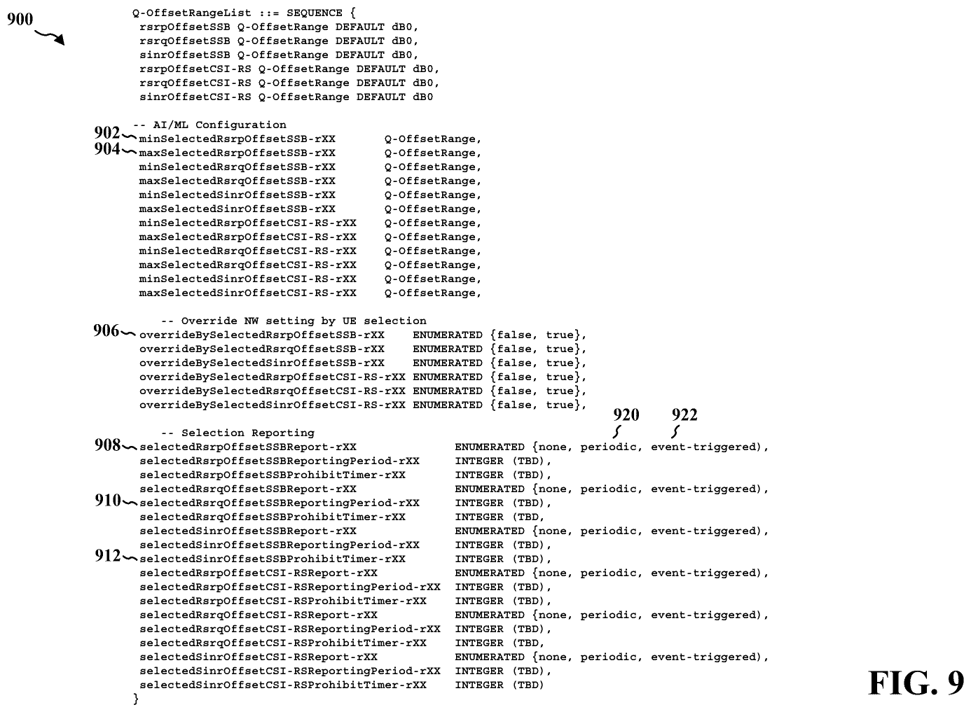

FIG. 9 is a diagram 900 illustrating example IEs for AI native mobility measurement parameters selection, in various aspects. For instance, the diagram 900 shows example AI/ML configuration IEs for minimum offset values (an IE 902, etc.) and for maximum offset values (an IE 904, etc.), e.g., associated with ranges, for allowed/enabled overrides (e.g., an IE 906, etc.), for reporting selection indications (e.g., an IE 908, etc.), for periodicity selection indications (e.g., an IE 910, etc.), for prohibit timer selection indications (e.g., an IE 912, etc.), for periodic reports (periodic indication 920, etc.), for event triggered reports (event-triggered indication 922, etc.), and/or the like, as described herein.

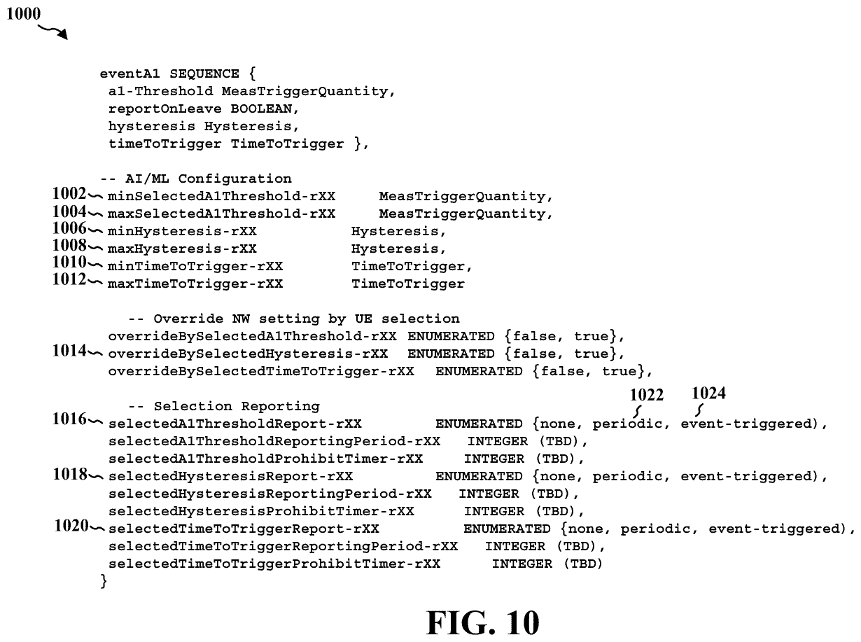

FIG. 10 is a diagram 1000 illustrating example IEs for AI native mobility measurement parameters selection, in various aspects. For instance, the diagram 1000 shows example AI/ML configuration IEs for minimum threshold values (an IE 1002, etc.) and for maximum threshold values (an IE 1004, etc.), e.g., associated with ranges, for minimum hysteresis values (an IE 1006, etc.) and for maximum hysteresis values (an IE 1008, etc.), e.g., associated with ranges, for minimum time to trigger values (an IE 1010, etc.) and for maximum time to trigger values (an IE 1012, etc.), e.g., associated with ranges, for allowed/enabled overrides (e.g., an IE 1014, etc.), for reporting selection indications (e.g., an IE 1016, etc.), for periodicity selection indications (e.g., an IE 1018, etc.), for prohibit timer selection indications (e.g., an IE 1020, etc.), for periodic reports (periodic indication 1022, etc.), for event triggered reports (event-triggered indication 1024, etc.), and/or the like, as described herein.

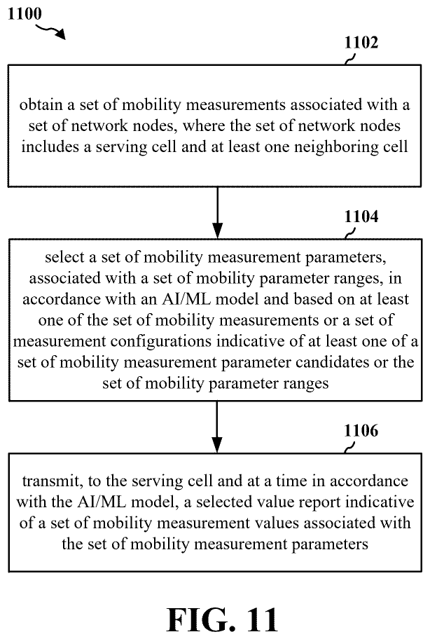

FIG. 11 is a flowchart 1100 of a method of wireless communication. The method may be performed by a UE (e.g., the UE 104, 502, 602, 702, 802; the apparatus 1104). The method may be for AI native mobility measurement parameters selection. The method may provide for improvements in the quality of a user experience in XR through increased robustness for radio-related situations for UEs, enable a UE to perform mobility measurement parameter selection(s) based on an AI/ML model within a configuration range allowed by the network, enable a network node to configure the UE for parameters, ranges, overrides, and/or reporting of values, and enable the network node to dynamically update parameter values for the UE. The method may also provide UE configurations for data collection and reporting, such as for each measurement configuration, and for UE fallback to network configured values based on performance, provide accommodations for timing of radio-related situations for UEs to prevent radio link failure and handover failure by enabling AI/ML selection/triggers of selected value reporting parameter values, refine and improve parameter value selection and implementation in wireless networks by enabling UE data collection and report of data and measurement values, and improve parameter value selection and implementation based on a UE perspective by enabling UE overrides of configured selected value reporting parameter values and value recommendations.

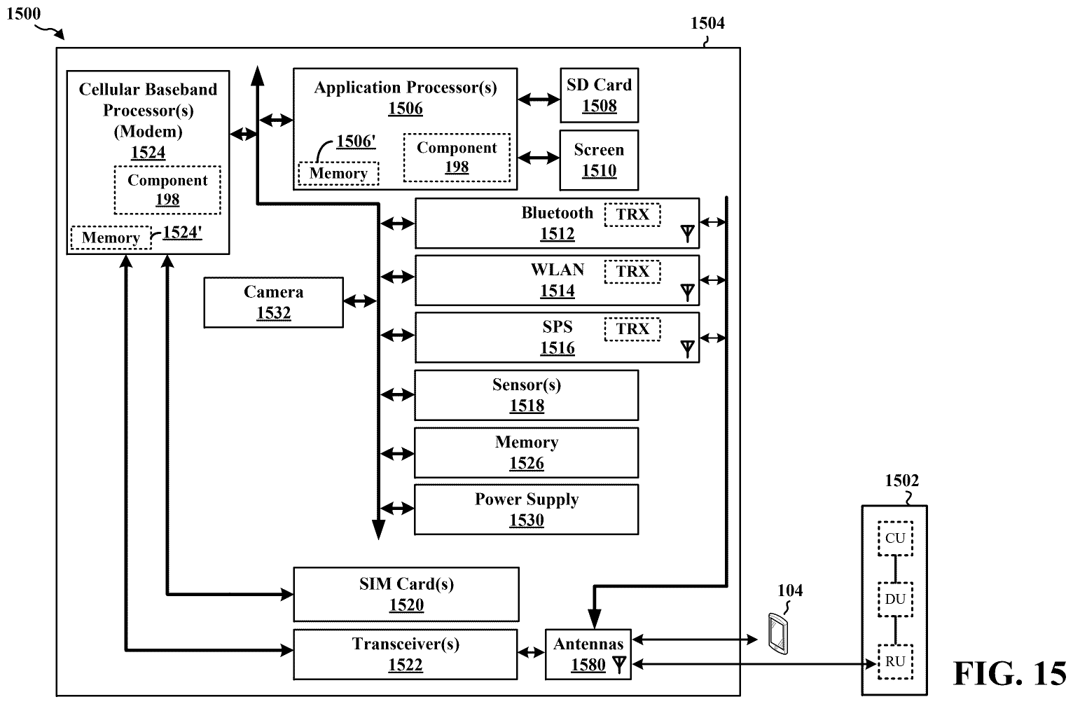

At 1102, the UE obtains a set of mobility measurements associated with a set of network nodes, where the set of network nodes includes a serving cell and at least one neighboring cell. As an example, the obtainment may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 obtaining such a set of mobility measurements.

The UE 502 may be configured to receive, and the base station 504 may be configured to transmit/provide/configure, via at least one of first RRC signaling, a first MAC-CE, or first DCI, a set of measurement configurations 506 (e.g., 606 in FIG. 6; 706 in FIG. 7; 806 in FIG. 8) indicative of at least one of a set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or a set of mobility parameter ranges (e.g., 616 in FIG. 6). The set of measurement configurations 506 (e.g., 606 in FIG. 6; 706 in FIG. 7; 806 in FIG. 8) may be indicative of at least one of a minimum value (e.g., 712 in FIG. 7), a maximum value (e.g., 714 in FIG. 7), or a set of candidate values (e.g., 716 in FIG. 7) for one or more of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). The set of measurement configurations 506 (e.g., 606 in FIG. 6; 706 in FIG. 7; 806 in FIG. 8) may be indicative of at least one enabled override (e.g., 724 in FIG. 7; 906 in FIG. 9; 1014 in FIG. 10) by the UE 502 for one or more of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). The set of measurement configurations 506 (e.g., 606 in FIG. 6; 706 in FIG. 7; 806 in FIG. 8) may be indicative of transmission for the selected value report 512 (e.g., 810 in FIG. 8) via at least one of RRC signaling, a MAC-CE, or UCI. In such aspects, the RRC signaling may include at least one of UAI (e.g., 752 in FIG. 7) or a separate measurement message (e.g., 754 in FIG. 7). In some aspects, the set of measurement configurations 506 (e.g., 606 in FIG. 6; 706 in FIG. 7; 806 in FIG. 8) may be indicative of the set of mobility measurement values (e.g., 760 in FIG. 7) for measurements. The set of measurement configurations 506 (e.g., 606 in FIG. 6; 706 in FIG. 7; 806 in FIG. 8) may be further indicative of a number and/or a list of mobility measurement values of the set of mobility measurement values (e.g., 760 in FIG. 7) that have been selected since a last selected value report (e.g., 810 in FIG. 8) and/or a last data collection report (e.g., 710 in FIG. 7) (e.g., a most recent instance of a transmission for the selected value report 512 (e.g., 810 in FIG. 8)/a data collection report (e.g., 710 in FIG. 7). The set of measurement configurations 506 (e.g., 606 in FIG. 6; 706 in FIG. 7; 806 in FIG. 8) may also be further indicative a transmission periodicity (e.g., 726 in FIG. 7; 816 in FIG. 8), a transmission event trigger (e.g., 728 in FIG. 7; 814 in FIG. 8), and/or a prohibit timer (e.g., 730 in FIG. 7; 818 in FIG. 8) associated with the selected value report 512 (e.g., 810 in FIG. 8). To receive the set of measurement configurations 506 (e.g., 606 in FIG. 6; 706 in FIG. 7; 806 in FIG. 8), the UE 502 may be configured to receive a set of dynamic measurement configuration updates (e.g., 608 in FIG. 6) associated with at least one of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or the set of mobility parameter ranges (e.g., 616 in FIG. 6), which the base station 504 may be configured to transmit/provide/configure. In some aspects, to receive the set of dynamic measurement configuration updates (e.g., 608 in FIG. 6), which the base station 504 may be configured to transmit/provide/configure, the UE 502 may be configured to receive, via second RRC signaling, a data structure indicative of a set of candidate mobility measurement values (e.g., 618 in FIG. 6) associated with at least one of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or the set of mobility parameter ranges (e.g., 616 in FIG. 6). In some aspects, to receive the set of dynamic measurement configuration updates (e.g., 608 in FIG. 6), which the base station 504 may be configured to transmit/provide/configure, the UE 502 may be configured to receive, via at least one of a second MAC-CE or second DCI, a set of data structure indices (e.g., 620 in FIG. 6) associated with the data structure indicative of the set of candidate mobility measurement values. In such aspects, the UE 502 may be configured to transmit/provide, and the base station 504 may be configured to receive, a HARQ-ACK (e.g., 610 in FIG. 6) based on reception of the set of data structure indices (e.g., 620 in FIG. 6). To receive the set of measurement configurations, the UE 502 may be configured to report (e.g., transmit/provide), and the base station 504 may be configured to receive, based on the set of measurement configurations 506 (e.g., 606 in FIG. 6; 706 in FIG. 7; 806 in FIG. 8), a capability indication (e.g., 605 in FIG. 6) indicative of at least one of (i) a parameter selection capability (e.g., 622 in FIG. 6) of the UE associated with mobility measurement parameters (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) based on the AI/ML model 550 (e.g., 650 in FIG. 6; 750 in FIG. 7; 850 in FIG. 8) or (ii) a data collection capability (e.g., 624 in FIG. 6) of the UE associated with at least one of a number or a list of mobility measurement values (e.g., 722 in FIG. 7) of the set of mobility measurement values (e.g., 760 in FIG. 7) that have been selected since a last selected value report (e.g., 810 in FIG. 8) and/or a last data collection report (e.g., a most recent instance of a transmission for the selected value report 512 (e.g., 810 in FIG. 8)/a data collection report, as described for FIG. 7). In aspects, the UE 502 may be configured to obtain (at 508) a set of mobility measurements associated with a set of network nodes. The set of network nodes may include a serving cell (e.g., a network node such as the base station 504, a gNB, etc.) and at least one neighboring cell (e.g., at least one network node such as the base station 505, a gNB, etc.) (e.g., 803, 805 in FIG. 8). In aspects, the UE 502 may be configured with the set of mobility measurements associated with the set of network nodes by one or more of the set of network nodes.

At 1104, the UE selects a set of mobility measurement parameters, associated with a set of mobility parameter ranges, in accordance with an AI/ML model and based on at least one of the set of mobility measurements or a set of measurement configurations indicative of at least one of a set of mobility measurement parameter candidates or the set of mobility parameter ranges. As an example, the selection may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 selecting such a set of mobility measurement parameters.

The UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10), associated with a set of mobility parameter ranges (e.g., 616 in FIG. 6), in accordance with an artificial intelligence AI/ML model 550 (e.g., 650 in FIG. 6; 750 in FIG. 7; 850 in FIG. 8) and based on at least one of the set of mobility measurements or the set of measurement configurations 506 (e.g., 606 in FIG. 6; 706 in FIG. 7; 806 in FIG. 8) indicative of at least one of a set of mobility measurement parameter candidates (e.g., 762 in FIG. 7) or the set of mobility parameter ranges (e.g., 616 in FIG. 6). In aspects, the UE 502 may be configured to select (at 510) at least one second mobility measurement parameter of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) that is different from at least one of the set of mobility measurement parameter candidates (e.g., based on an override by the UE 502) (e.g., 762 in FIG. 7) or the set of mobility parameter ranges (e.g., 616 in FIG. 6). In aspects, the UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) in accordance with the set of measurement configurations 506 (e.g., 606 in FIG. 6; 706 in FIG. 7; 806 in FIG. 8) indicative of at least one of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or the set of mobility parameter ranges (e.g., 616 in FIG. 6). In aspects, the UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) in accordance with a selection indication included in the set of measurement configurations 506 (e.g., 606 in FIG. 6; 706 in FIG. 7; 806 in FIG. 8). In aspects, the UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) as including to measure (e.g., at 809 in FIG. 8) the set of mobility measurement values (e.g., 760 in FIG. 7) in accordance with the set of measurement configurations 506 (e.g., 606 in FIG. 6; 706 in FIG. 7; 806 in FIG. 8) being indicative of the set of mobility measurement values (e.g., 760 in FIG. 7) for the measurements (e.g., at 809 in FIG. 8).

At 1106, the UE transmits, to the serving cell and at a time in accordance with the AI/ML model, a selected value report indicative of a set of mobility measurement values associated with the set of mobility measurement parameters. As an example, the transmission may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 transmitting such a selected value report to a network node as a serving cell (e.g., the base station 504).

The UE 502 may be configured to transmit/provide, to the serving cell (e.g., the base station 504 which may be configured to receive), at a time in accordance with the AI/ML model 550 (e.g., 650 in FIG. 6; 750 in FIG. 7; 850 in FIG. 8), a selected value report (SVR) 512 (e.g., 810 in FIG. 8). The selected value report 512 (e.g., 810 in FIG. 8) may be indicative of a set of mobility measurement values (e.g., 760 in FIG. 7) associated with the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). In aspects, the UE 502 may be configured to transmit the selected value report 512 (e.g., 810 in FIG. 8) in accordance with the set of measurement configurations 506 (e.g., 606 in FIG. 6; 706 in FIG. 7; 806 in FIG. 8). The set of measurement configurations 506 (e.g., 606 in FIG. 6; 706 in FIG. 7; 806 in FIG. 8) may be indicative of at least one of periodic transmission (e.g., 732 in FIG. 7) or event triggered transmission (e.g., 734 in FIG. 7) of the selected value report 512 (e.g., 810 in FIG. 8). The UE 502 may be configured to transmit/provide the selected value report 512 (e.g., 810 in FIG. 8) based on a prohibit timer (e.g., 730 in FIG. 7; 818 in FIG. 8) that is indicative of a time period during which the transmission of the selected value report (e.g., 810 in FIG. 8) is prohibited.

In aspects, the UE 502 may be configured to fall back to indications/settings/values of the set of measurement configurations 506 (e.g., 606 in FIG. 6; 706 in FIG. 7; 806 in FIG. 8), e.g., based on worsening performance associated with overrides/recommendations selected (e.g., at 510) for the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). The UE 502 may be configured to revert (e.g., 826 in FIG. 8) to a set of candidate mobility measurement values (e.g., 760 in FIG. 7), associated with the serving cell (e.g., the base station 504), for the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) based on a radio link failure or a handover failure (e.g., 824 in FIG. 8), in some aspects. In aspects, based on the reversion (e.g., 826 in FIG. 8) and/or the failure (e.g., 824 in FIG. 8), a prohibit timer (e.g., 828 in FIG. 8) may be activated during which the UE 502 may not be allowed/enabled to use a set of mobility measurement parameters selected by the UE 502. Additionally, the UE 502 may be configured to reselect (e.g., at 834 in FIG. 8) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) in accordance with the AI/ML model 550 (e.g., 650 in FIG. 6; 750 in FIG. 7; 850 in FIG. 8) based on an expiration (e.g., 832 in FIG. 8) of a prohibit timer (e.g., 828 in FIG. 8) associated with a reversion to the set of candidate mobility measurement values (e.g., 760 in FIG. 7), in some aspects.

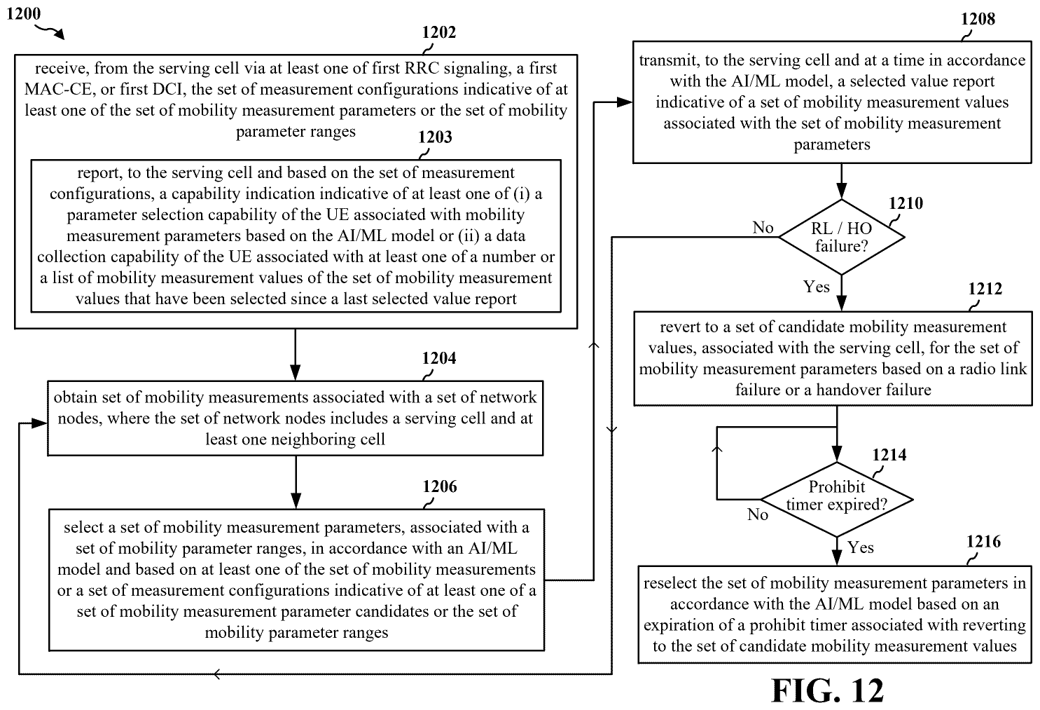

FIG. 12 is a flowchart 1200 of a method of wireless communication. The method may be performed by a UE (e.g., the UE 104, 502, 602, 702, 802; the apparatus 1104). The method may be for AI native mobility measurement parameters selection. The method may provide for improvements in the quality of a user experience in XR through increased robustness for radio-related situations for UEs, enable a UE to perform mobility measurement parameter selection(s) based on an AI/ML model within a configuration range allowed by the network, enable a network node to configure the UE for parameters, ranges, overrides, and/or reporting of values, and enable the network node to dynamically update parameter values for the UE. The method may also provide UE configurations for data collection and reporting, such as for each measurement configuration, and for UE fallback to network configured values based on performance, provide accommodations for timing of radio-related situations for UEs to prevent radio link failure and handover failure by enabling AI/ML selection/triggers of selected value reporting parameter values, refine and improve parameter value selection and implementation in wireless networks by enabling UE data collection and report of data and measurement values, and improve parameter value selection and implementation based on a UE perspective by enabling UE overrides of configured selected value reporting parameter values and value recommendations.

At 1202, the UE receive, from the serving cell via at least one of first RRC signaling, a first MAC-CE, or first DCI, the set of measurement configurations indicative of at least one of the set of mobility measurement parameters or the set of mobility parameter ranges. As an example, the reception may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 receiving such a set of measurement configurations from a network node as a serving cell (e.g., the base station 504).

The UE 502 may be configured to receive, and the base station 504 may be configured to transmit/provide/configure, via at least one of first RRC signaling, a first MAC-CE, or first DCI, a set of measurement configurations 506 (e.g., 606 in FIG. 6; 706 in FIG. 7; 806 in FIG. 8) indicative of at least one of a set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or a set of mobility parameter ranges (e.g., 616 in FIG. 6). The set of measurement configurations 506 (e.g., 606 in FIG. 6; 706 in FIG. 7; 806 in FIG. 8) may be indicative of at least one of a minimum value (e.g., 712 in FIG. 7), a maximum value (e.g., 714 in FIG. 7), or a set of candidate values (e.g., 716 in FIG. 7) for one or more of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). The set of measurement configurations 506 (e.g., 606 in FIG. 6; 706 in FIG. 7; 806 in FIG. 8) may be indicative of at least one enabled override (e.g., 724 in FIG. 7; 906 in FIG. 9; 1014 in FIG. 10) by the UE 502 for one or more of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). The set of measurement configurations 506 (e.g., 606 in FIG. 6; 706 in FIG. 7; 806 in FIG. 8) may be indicative of transmission for the selected value report 512 (e.g., 810 in FIG. 8) via at least one of RRC signaling, a MAC-CE, or UCI. In such aspects, the RRC signaling may include at least one of UAI (e.g., 752 in FIG. 7) or a separate measurement message (e.g., 754 in FIG. 7). In some aspects, the set of measurement configurations 506 (e.g., 606 in FIG. 6; 706 in FIG. 7; 806 in FIG. 8) may be indicative of the set of mobility measurement values (e.g., 760 in FIG. 7) for measurements. The set of measurement configurations 506 (e.g., 606 in FIG. 6; 706 in FIG. 7; 806 in FIG. 8) may be further indicative of a number and/or a list of mobility measurement values of the set of mobility measurement values (e.g., 760 in FIG. 7) that have been selected since a last selected value report (e.g., 810 in FIG. 8) and/or a last data collection report (e.g., 710 in FIG. 7) (e.g., a most recent instance of a transmission for the selected value report 512 (e.g., 810 in FIG. 8)/a data collection report (e.g., 710 in FIG. 7). The set of measurement configurations 506 (e.g., 606 in FIG. 6; 706 in FIG. 7; 806 in FIG. 8) may also be further indicative a transmission periodicity (e.g., 726 in FIG. 7; 816 in FIG. 8), a transmission event trigger (e.g., 728 in FIG. 7; 814 in FIG. 8), and/or a prohibit timer (e.g., 730 in FIG. 7; 818 in FIG. 8) associated with the selected value report 512 (e.g., 810 in FIG. 8). To receive the set of measurement configurations 506 (e.g., 606 in FIG. 6; 706 in FIG. 7; 806 in FIG. 8), the UE 502 may be configured to receive a set of dynamic measurement configuration updates (e.g., 608 in FIG. 6) associated with at least one of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or the set of mobility parameter ranges (e.g., 616 in FIG. 6), which the base station 504 may be configured to transmit/provide/configure. In some aspects, to receive the set of dynamic measurement configuration updates (e.g., 608 in FIG. 6), which the base station 504 may be configured to transmit/provide/configure, the UE 502 may be configured to receive, via second RRC signaling, a data structure indicative of a set of candidate mobility measurement values (e.g., 618 in FIG. 6) associated with at least one of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or the set of mobility parameter ranges (e.g., 616 in FIG. 6). In some aspects, to receive the set of dynamic measurement configuration updates (e.g., 608 in FIG. 6), which the base station 504 may be configured to transmit/provide/configure, the UE 502 may be configured to receive, via at least one of a second MAC-CE or second DCI, a set of data structure indices (e.g., 620 in FIG. 6) associated with the data structure indicative of the set of candidate mobility measurement values. In such aspects, the UE 502 may be configured to transmit/provide, and the base station 504 may be configured to receive, a HARQ-ACK (e.g., 610 in FIG. 6) based on reception of the set of data structure indices (e.g., 620 in FIG. 6).

To receive the set of measurement configurations at 1202, the UE 502 may be configured to report (e.g., transmit/provide), at 1203, and the base station 504 may be configured to receive, based on the set of measurement configurations 506 (e.g., 606 in FIG. 6; 706 in FIG. 7; 806 in FIG. 8), a capability indication (e.g., 605 in FIG. 6) indicative of at least one of (i) a parameter selection capability (e.g., 622 in FIG. 6) of the UE associated with mobility measurement parameters (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) based on the AI/ML model 550 (e.g., 650 in FIG. 6; 750 in FIG. 7; 850 in FIG. 8) or (ii) a data collection capability (e.g., 624 in FIG. 6) of the UE associated with at least one of a number or a list of mobility measurement values (e.g., 722 in FIG. 7) of the set of mobility measurement values (e.g., 760 in FIG. 7) that have been selected since a last selected value report (e.g., 810 in FIG. 8) and/or a last data collection report (e.g., a most recent instance of a transmission for the selected value report 512 (e.g., 810 in FIG. 8)/a data collection report, as described for FIG. 7).

At 1204, the UE obtains a set of mobility measurements associated with a set of network nodes, where the set of network nodes includes a serving cell and at least one neighboring cell. As an example, the obtainment may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 obtaining such a set of mobility measurements.

In aspects, the UE 502 may be configured to obtain (at 508) a set of mobility measurements associated with a set of network nodes. The set of network nodes may include a serving cell (e.g., a network node such as the base station 504, a gNB, etc.) and at least one neighboring cell (e.g., at least one network node such as the base station 505, a gNB, etc.) (e.g., 803, 805 in FIG. 8). In aspects, the UE 502 may be configured with the set of mobility measurements associated with the set of network nodes by one or more of the set of network nodes.

At 1206, the UE selects a set of mobility measurement parameters, associated with a set of mobility parameter ranges, in accordance with an AI/ML model and based on at least one of the set of mobility measurements or a set of measurement configurations indicative of at least one of a set of mobility measurement parameter candidates or the set of mobility parameter ranges. As an example, the selection may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 selecting such a set of mobility measurement parameters.

The UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10), associated with a set of mobility parameter ranges (e.g., 616 in FIG. 6), in accordance with an artificial intelligence AI/ML model 550 (e.g., 650 in FIG. 6; 750 in FIG. 7; 850 in FIG. 8) and based on at least one of the set of mobility measurements or the set of measurement configurations 506 (e.g., 606 in FIG. 6; 706 in FIG. 7; 806 in FIG. 8) indicative of at least one of a set of mobility measurement parameter candidates (e.g., 762 in FIG. 7) or the set of mobility parameter ranges (e.g., 616 in FIG. 6). In aspects, the UE 502 may be configured to select (at 510) at least one second mobility measurement parameter of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) that is different from at least one of the set of mobility measurement parameter candidates (e.g., based on an override by the UE 502) (e.g., 762 in FIG. 7) or the set of mobility parameter ranges (e.g., 616 in FIG. 6). In aspects, the UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) in accordance with the set of measurement configurations 506 (e.g., 606 in FIG. 6; 706 in FIG. 7; 806 in FIG. 8) indicative of at least one of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or the set of mobility parameter ranges (e.g., 616 in FIG. 6). In aspects, the UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) in accordance with a selection indication included in the set of measurement configurations 506 (e.g., 606 in FIG. 6; 706 in FIG. 7; 806 in FIG. 8). In aspects, the UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) as including to measure (e.g., at 809 in FIG. 8) the set of mobility measurement values (e.g., 760 in FIG. 7) in accordance with the set of measurement configurations 506 (e.g., 606 in FIG. 6; 706 in FIG. 7; 806 in FIG. 8) being indicative of the set of mobility measurement values (e.g., 760 in FIG. 7) for the measurements (e.g., at 809 in FIG. 8).

At 1208, the UE transmits, to the serving cell and at a time in accordance with the AI/ML model, a selected value report indicative of a set of mobility measurement values associated with the set of mobility measurement parameters. As an example, the transmission may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 transmitting such a selected value report to a network node as a serving cell (e.g., the base station 504).

The UE 502 may be configured to transmit/provide, to the serving cell (e.g., the base station 504 which may be configured to receive), at a time in accordance with the AI/ML model 550 (e.g., 650 in FIG. 6; 750 in FIG. 7; 850 in FIG. 8), a selected value report (SVR) 512 (e.g., 810 in FIG. 8). The selected value report 512 (e.g., 810 in FIG. 8) may be indicative of a set of mobility measurement values (e.g., 760 in FIG. 7) associated with the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). In aspects, the UE 502 may be configured to transmit the selected value report 512 (e.g., 810 in FIG. 8) in accordance with the set of measurement configurations 506 (e.g., 606 in FIG. 6; 706 in FIG. 7; 806 in FIG. 8). The set of measurement configurations 506 (e.g., 606 in FIG. 6; 706 in FIG. 7; 806 in FIG. 8) may be indicative of at least one of periodic transmission (e.g., 732 in FIG. 7) or event triggered transmission (e.g., 734 in FIG. 7) of the selected value report 512 (e.g., 810 in FIG. 8). The UE 502 may be configured to transmit/provide the selected value report 512 (e.g., 810 in FIG. 8) based on a prohibit timer (e.g., 730 in FIG. 7; 818 in FIG. 8) that is indicative of a time period during which the transmission of the selected value report (e.g., 810 in FIG. 8) is prohibited.

At 1210, the UE determines if a radio link (RL) or handover (HO) failure will occur or has occurred. As an example, the determination may be performed by one or more of the component 198, the transceiver(s) 1522, and/or the antenna 1580 in FIG. 15. If no failure has occurred or is determined to occur, flowchart 1200 may return to 1204 or another prior operation. If failure is detected, the flowchart 1200 may continue to 1212.

In aspects, the UE 502 may be configured to fall back to indications/settings/values of the set of measurement configurations 506 (e.g., 606 in FIG. 6; 706 in FIG. 7; 806 in FIG. 8), e.g., based on worsening performance associated with overrides/recommendations selected (e.g., at 510) for the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10).

At 1212, the UE revert to a set of candidate mobility measurement values, associated with the serving cell, for the set of mobility measurement parameters based on a radio link failure or a handover failure. As an example, the reversion may be performed by one or more of the component 198, the transceiver(s) 1522, and/or the antenna 1580 in FIG. 15. FIG. 5 illustrates, in the context of FIGS. 6, 7, 8, 9, 10, an example of the UE 502 reverting to such candidate mobility measurement values.

The UE 502 may be configured to revert (e.g., 826 in FIG. 8) to a set of candidate mobility measurement values (e.g., 760 in FIG. 7), associated with the serving cell (e.g., the base station 504), for the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) based on a radio link failure or a handover failure (e.g., 824 in FIG. 8), in some aspects. In aspects, based on the reversion (e.g., 826 in FIG. 8) and/or the failure (e.g., 824 in FIG. 8), a prohibit timer (e.g., 828 in FIG. 8) may be activated during which the UE 502 may not be allowed/enabled to use a set of mobility measurement parameters selected by the UE 502.

At 1210, the UE determines if the prohibit timer has expired. As an example, the determination may be performed by one or more of the component 198, the transceiver(s) 1522, and/or the antenna 1580 in FIG. 15. If the prohibit timer has expired, flowchart 1200 may continue to 1216; if not, the UE waits for expiration at 1214.

Additionally, the UE 502 may be configured to reselect (e.g., at 834 in FIG. 8) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) in accordance with the AI/ML model 550 (e.g., 650 in FIG. 6; 750 in FIG. 7; 850 in FIG. 8) based on an expiration (e.g., 832 in FIG. 8) of a prohibit timer (e.g., 828 in FIG. 8) associated with a reversion to the set of candidate mobility measurement values (e.g., 760 in FIG. 7), in some aspects.

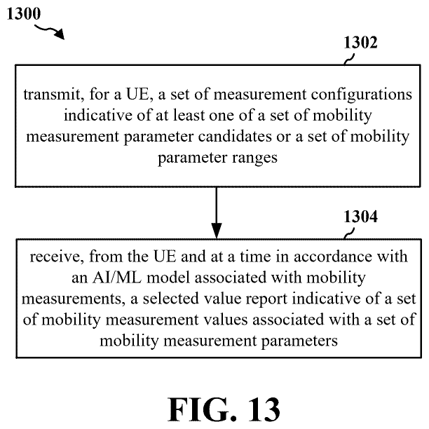

FIG. 13 is a flowchart 1300 of a method of wireless communication. The method may be performed by a network node (e.g., as a serving cell) (e.g., the base station 102, 504, 604, 704, 804; the network entity 1502, 1602). The method may be for AI native mobility measurement parameters selection. The method may provide for improvements in the quality of a user experience in XR through increased robustness for radio-related situations for UEs, enable a UE to perform mobility measurement parameter selection(s) based on an AI/ML model within a configuration range allowed by the network, enable a network node to configure the UE for parameters, ranges, overrides, and/or reporting of values, and enable the network node to dynamically update parameter values for the UE. The method may also provide UE configurations for data collection and reporting, such as for each measurement configuration, and for UE fallback to network configured values based on performance, provide accommodations for timing of radio-related situations for UEs to prevent radio link failure and handover failure by enabling AI/ML selection/triggers of selected value reporting parameter values, refine and improve parameter value selection and implementation in wireless networks by enabling UE data collection and report of data and measurement values, and improve parameter value selection and implementation based on a UE perspective by enabling UE overrides of configured selected value reporting parameter values and value recommendations.

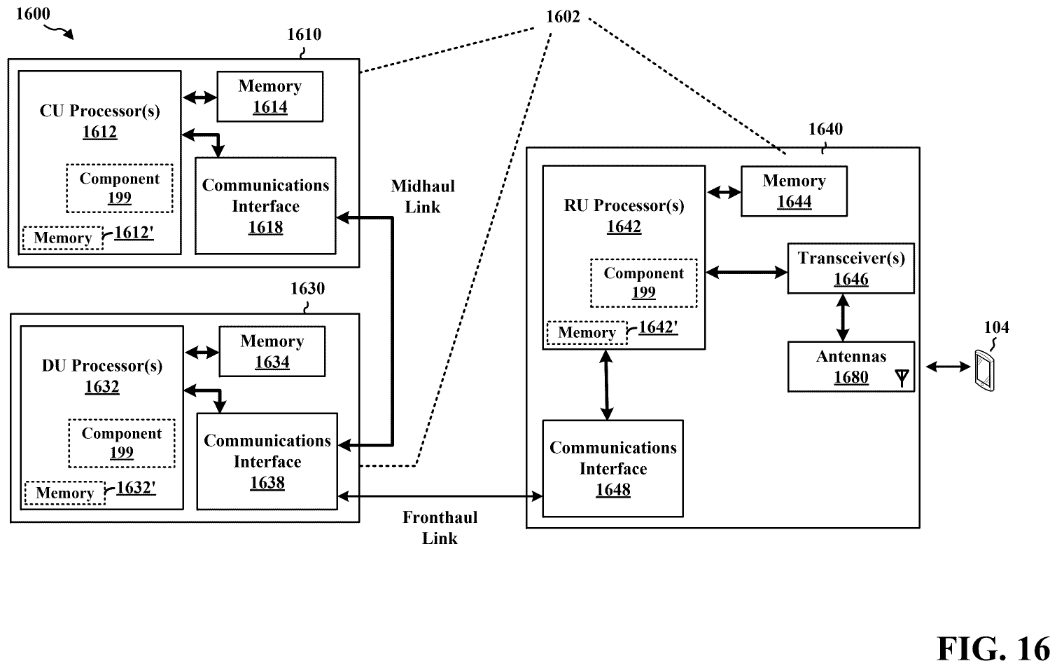

At 1302, the network node transmits, for a UE, a set of measurement configurations indicative of at least one of a set of mobility measurement parameter candidates or a set of mobility parameter ranges. As an example, the transmission may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) transmitting such a set of measurement configurations for a UE (e.g., the UE 502).

The UE 502 may be configured to receive, and the base station 504 may be configured to transmit/provide/configure, via at least one of first RRC signaling, a first MAC-CE, or first DCI, a set of measurement configurations 506 (e.g., 606 in FIG. 6; 706 in FIG. 7; 806 in FIG. 8) indicative of at least one of a set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or a set of mobility parameter ranges (e.g., 616 in FIG. 6). The set of measurement configurations 506 (e.g., 606 in FIG. 6; 706 in FIG. 7; 806 in FIG. 8) may be indicative of at least one of a minimum value (e.g., 712 in FIG. 7), a maximum value (e.g., 714 in FIG. 7), or a set of candidate values (e.g., 716 in FIG. 7) for one or more of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). The set of measurement configurations 506 (e.g., 606 in FIG. 6; 706 in FIG. 7; 806 in FIG. 8) may be indicative of at least one enabled override (e.g., 724 in FIG. 7; 906 in FIG. 9; 1014 in FIG. 10) by the UE 502 for one or more of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). The set of measurement configurations 506 (e.g., 606 in FIG. 6; 706 in FIG. 7; 806 in FIG. 8) may be indicative of transmission for the selected value report 512 (e.g., 810 in FIG. 8) via at least one of RRC signaling, a MAC-CE, or UCI. In such aspects, the RRC signaling may include at least one of UAI (e.g., 752 in FIG. 7) or a separate measurement message (e.g., 754 in FIG. 7). In some aspects, the set of measurement configurations 506 (e.g., 606 in FIG. 6; 706 in FIG. 7; 806 in FIG. 8) may be indicative of the set of mobility measurement values (e.g., 760 in FIG. 7) for measurements. The set of measurement configurations 506 (e.g., 606 in FIG. 6; 706 in FIG. 7; 806 in FIG. 8) may be further indicative of a number and/or a list of mobility measurement values of the set of mobility measurement values (e.g., 760 in FIG. 7) that have been selected since a last selected value report (e.g., 810 in FIG. 8) and/or a last data collection report (e.g., 710 in FIG. 7) (e.g., a most recent instance of a transmission for the selected value report 512 (e.g., 810 in FIG. 8)/a data collection report (e.g., 710 in FIG. 7). The set of measurement configurations 506 (e.g., 606 in FIG. 6; 706 in FIG. 7; 806 in FIG. 8) may also be further indicative a transmission periodicity (e.g., 726 in FIG. 7; 816 in FIG. 8), a transmission event trigger (e.g., 728 in FIG. 7; 814 in FIG. 8), and/or a prohibit timer (e.g., 730 in FIG. 7; 818 in FIG. 8) associated with the selected value report 512 (e.g., 810 in FIG. 8). To receive the set of measurement configurations 506 (e.g., 606 in FIG. 6; 706 in FIG. 7; 806 in FIG. 8), the UE 502 may be configured to receive a set of dynamic measurement configuration updates (e.g., 608 in FIG. 6) associated with at least one of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or the set of mobility parameter ranges (e.g., 616 in FIG. 6), which the base station 504 may be configured to transmit/provide/configure. In some aspects, to receive the set of dynamic measurement configuration updates (e.g., 608 in FIG. 6), which the base station 504 may be configured to transmit/provide/configure, the UE 502 may be configured to receive, via second RRC signaling, a data structure indicative of a set of candidate mobility measurement values (e.g., 618 in FIG. 6) associated with at least one of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or the set of mobility parameter ranges (e.g., 616 in FIG. 6). In some aspects, to receive the set of dynamic measurement configuration updates (e.g., 608 in FIG. 6), which the base station 504 may be configured to transmit/provide/configure, the UE 502 may be configured to receive, via at least one of a second MAC-CE or second DCI, a set of data structure indices (e.g., 620 in FIG. 6) associated with the data structure indicative of the set of candidate mobility measurement values. In such aspects, the UE 502 may be configured to transmit/provide, and the base station 504 may be configured to receive, a HARQ-ACK (e.g., 610 in FIG. 6) based on reception of the set of data structure indices (e.g., 620 in FIG. 6). To receive the set of measurement configurations, the UE 502 may be configured to report (e.g., transmit/provide), and the base station 504 may be configured to receive, based on the set of measurement configurations 506 (e.g., 606 in FIG. 6; 706 in FIG. 7; 806 in FIG. 8), a capability indication (e.g., 605 in FIG. 6) indicative of at least one of (i) a parameter selection capability (e.g., 622 in FIG. 6) of the UE associated with mobility measurement parameters (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) based on the AI/ML model 550 (e.g., 650 in FIG. 6; 750 in FIG. 7; 850 in FIG. 8) or (ii) a data collection capability (e.g., 624 in FIG. 6) of the UE associated with at least one of a number or a list of mobility measurement values (e.g., 722 in FIG. 7) of the set of mobility measurement values (e.g., 760 in FIG. 7) that have been selected since a last selected value report (e.g., 810 in FIG. 8) and/or a last data collection report (e.g., a most recent instance of a transmission for the selected value report 512 (e.g., 810 in FIG. 8)/a data collection report, as described for FIG. 7). In aspects, the UE 502 may be configured to obtain (at 508) a set of mobility measurements associated with a set of network nodes. The set of network nodes may include a serving cell (e.g., a network node such as the base station 504, a gNB, etc.) and at least one neighboring cell (e.g., at least one network node such as the base station 505, a gNB, etc.) (e.g., 803, 805 in FIG. 8). In aspects, the UE 502 may be configured with the set of mobility measurements associated with the set of network nodes by one or more of the set of network nodes. The UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10), associated with a set of mobility parameter ranges (e.g., 616 in FIG. 6), in accordance with an artificial intelligence AI/ML model 550 (e.g., 650 in FIG. 6; 750 in FIG. 7; 850 in FIG. 8) and based on at least one of the set of mobility measurements or the set of measurement configurations 506 (e.g., 606 in FIG. 6; 706 in FIG. 7; 806 in FIG. 8) indicative of at least one of a set of mobility measurement parameter candidates (e.g., 762 in FIG. 7) or the set of mobility parameter ranges (e.g., 616 in FIG. 6). In aspects, the UE 502 may be configured to select (at 510) at least one second mobility measurement parameter of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) that is different from at least one of the set of mobility measurement parameter candidates (e.g., based on an override by the UE 502) (e.g., 762 in FIG. 7) or the set of mobility parameter ranges (e.g., 616 in FIG. 6). In aspects, the UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) in accordance with the set of measurement configurations 506 (e.g., 606 in FIG. 6; 706 in FIG. 7; 806 in FIG. 8) indicative of at least one of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or the set of mobility parameter ranges (e.g., 616 in FIG. 6). In aspects, the UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) in accordance with a selection indication included in the set of measurement configurations 506 (e.g., 606 in FIG. 6; 706 in FIG. 7; 806 in FIG. 8). In aspects, the UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) as including to measure (e.g., at 809 in FIG. 8) the set of mobility measurement values (e.g., 760 in FIG. 7) in accordance with the set of measurement configurations 506 (e.g., 606 in FIG. 6; 706 in FIG. 7; 806 in FIG. 8) being indicative of the set of mobility measurement values (e.g., 760 in FIG. 7) for the measurements (e.g., at 809 in FIG. 8).

At 1304, the network node receives, from the UE and at a time in accordance with an AI/ML model associated with mobility measurements, a selected value report indicative of a set of mobility measurement values associated with a set of mobility measurement parameters. As an example, the reception may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) receiving such a selected value report from a UE (e.g., the UE 502).

The UE 502 may be configured to transmit/provide, to the serving cell (e.g., the base station 504 which may be configured to receive), at a time in accordance with the AI/ML model 550 (e.g., 650 in FIG. 6; 750 in FIG. 7; 850 in FIG. 8), a selected value report (SVR) 512 (e.g., 810 in FIG. 8). The selected value report 512 (e.g., 810 in FIG. 8) may be indicative of a set of mobility measurement values (e.g., 760 in FIG. 7) associated with the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). In aspects, the UE 502 may be configured to transmit the selected value report 512 (e.g., 810 in FIG. 8) in accordance with the set of measurement configurations 506 (e.g., 606 in FIG. 6; 706 in FIG. 7; 806 in FIG. 8). The set of measurement configurations 506 (e.g., 606 in FIG. 6; 706 in FIG. 7; 806 in FIG. 8) may be indicative of at least one of periodic transmission (e.g., 732 in FIG. 7) or event triggered transmission (e.g., 734 in FIG. 7) of the selected value report 512 (e.g., 810 in FIG. 8). The UE 502 may be configured to transmit/provide the selected value report 512 (e.g., 810 in FIG. 8) based on a prohibit timer (e.g., 730 in FIG. 7; 818 in FIG. 8) that is indicative of a time period during which the transmission of the selected value report (e.g., 810 in FIG. 8) is prohibited.

In aspects, the UE 502 may be configured to fall back to indications/settings/values of the set of measurement configurations 506 (e.g., 606 in FIG. 6; 706 in FIG. 7; 806 in FIG. 8), e.g., based on worsening performance associated with overrides/recommendations selected (e.g., at 510) for the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). The UE 502 may be configured to revert (e.g., 826 in FIG. 8) to a set of candidate mobility measurement values (e.g., 760 in FIG. 7), associated with the serving cell (e.g., the base station 504), for the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) based on a radio link failure or a handover failure (e.g., 824 in FIG. 8), in some aspects. In aspects, based on the reversion (e.g., 826 in FIG. 8) and/or the failure (e.g., 824 in FIG. 8), a prohibit timer (e.g., 828 in FIG. 8) may be activated during which the UE 502 may not be allowed/enabled to use a set of mobility measurement parameters selected by the UE 502. Additionally, the UE 502 may be configured to reselect (e.g., at 834 in FIG. 8) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) in accordance with the AI/ML model 550 (e.g., 650 in FIG. 6; 750 in FIG. 7; 850 in FIG. 8) based on an expiration (e.g., 832 in FIG. 8) of a prohibit timer (e.g., 828 in FIG. 8) associated with a reversion to the set of candidate mobility measurement values (e.g., 760 in FIG. 7), in some aspects.

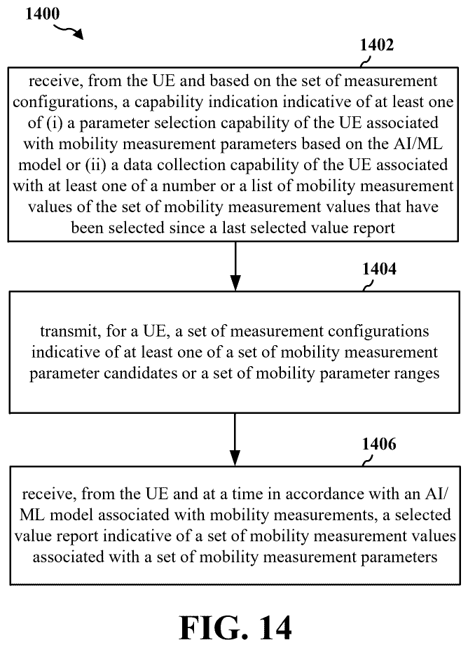

FIG. 14 is a flowchart 1400 of a method of wireless communication. The method may be performed by a network node (e.g., as a serving cell) (e.g., the base station 102, 504, 604, 704, 804; the network entity 1502, 1602). The method may be for AI native mobility measurement parameters selection. The method may provide for improvements in the quality of a user experience in XR through increased robustness for radio-related situations for UEs, enable a UE to perform mobility measurement parameter selection(s) based on an AI/ML model within a configuration range allowed by the network, enable a network node to configure the UE for parameters, ranges, overrides, and/or reporting of values, and enable the network node to dynamically update parameter values for the UE. The method may also provide UE configurations for data collection and reporting, such as for each measurement configuration, and for UE fallback to network configured values based on performance, provide accommodations for timing of radio-related situations for UEs to prevent radio link failure and handover failure by enabling AI/ML selection/triggers of selected value reporting parameter values, refine and improve parameter value selection and implementation in wireless networks by enabling UE data collection and report of data and measurement values, and improve parameter value selection and implementation based on a UE perspective by enabling UE overrides of configured selected value reporting parameter values and value recommendations.

At 1402, the network node transmits, for a UE, a set of measurement configurations indicative of at least one of a set of mobility measurement parameter candidates or a set of mobility parameter ranges. As an example, the transmission may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) transmitting such a set of measurement configurations for a UE (e.g., the UE 502).

The UE 502 may be configured to receive, and the base station 504 may be configured to transmit/provide/configure, via at least one of first RRC signaling, a first MAC-CE, or first DCI, a set of measurement configurations 506 (e.g., 606 in FIG. 6; 706 in FIG. 7; 806 in FIG. 8) indicative of at least one of a set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or a set of mobility parameter ranges (e.g., 616 in FIG. 6). The set of measurement configurations 506 (e.g., 606 in FIG. 6; 706 in FIG. 7; 806 in FIG. 8) may be indicative of at least one of a minimum value (e.g., 712 in FIG. 7), a maximum value (e.g., 714 in FIG. 7), or a set of candidate values (e.g., 716 in FIG. 7) for one or more of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). The set of measurement configurations 506 (e.g., 606 in FIG. 6; 706 in FIG. 7; 806 in FIG. 8) may be indicative of at least one enabled override (e.g., 724 in FIG. 7; 906 in FIG. 9; 1014 in FIG. 10) by the UE 502 for one or more of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). The set of measurement configurations 506 (e.g., 606 in FIG. 6; 706 in FIG. 7; 806 in FIG. 8) may be indicative of transmission for the selected value report 512 (e.g., 810 in FIG. 8) via at least one of RRC signaling, a MAC-CE, or UCI. In such aspects, the RRC signaling may include at least one of UAI (e.g., 752 in FIG. 7) or a separate measurement message (e.g., 754 in FIG. 7). In some aspects, the set of measurement configurations 506 (e.g., 606 in FIG. 6; 706 in FIG. 7; 806 in FIG. 8) may be indicative of the set of mobility measurement values (e.g., 760 in FIG. 7) for measurements. The set of measurement configurations 506 (e.g., 606 in FIG. 6; 706 in FIG. 7; 806 in FIG. 8) may be further indicative of a number and/or a list of mobility measurement values of the set of mobility measurement values (e.g., 760 in FIG. 7) that have been selected since a last selected value report (e.g., 810 in FIG. 8) and/or a last data collection report (e.g., 710 in FIG. 7) (e.g., a most recent instance of a transmission for the selected value report 512 (e.g., 810 in FIG. 8)/a data collection report (e.g., 710 in FIG. 7). The set of measurement configurations 506 (e.g., 606 in FIG. 6; 706 in FIG. 7; 806 in FIG. 8) may also be further indicative a transmission periodicity (e.g., 726 in FIG. 7; 816 in FIG. 8), a transmission event trigger (e.g., 728 in FIG. 7; 814 in FIG. 8), and/or a prohibit timer (e.g., 730 in FIG. 7; 818 in FIG. 8) associated with the selected value report 512 (e.g., 810 in FIG. 8). To receive the set of measurement configurations 506 (e.g., 606 in FIG. 6; 706 in FIG. 7; 806 in FIG. 8), the UE 502 may be configured to receive a set of dynamic measurement configuration updates (e.g., 608 in FIG. 6) associated with at least one of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or the set of mobility parameter ranges (e.g., 616 in FIG. 6), which the base station 504 may be configured to transmit/provide/configure. In some aspects, to receive the set of dynamic measurement configuration updates (e.g., 608 in FIG. 6), which the base station 504 may be configured to transmit/provide/configure, the UE 502 may be configured to receive, via second RRC signaling, a data structure indicative of a set of candidate mobility measurement values (e.g., 618 in FIG. 6) associated with at least one of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or the set of mobility parameter ranges (e.g., 616 in FIG. 6). In some aspects, to receive the set of dynamic measurement configuration updates (e.g., 608 in FIG. 6), which the base station 504 may be configured to transmit/provide/configure, the UE 502 may be configured to receive, via at least one of a second MAC-CE or second DCI, a set of data structure indices (e.g., 620 in FIG. 6) associated with the data structure indicative of the set of candidate mobility measurement values. In such aspects, the UE 502 may be configured to transmit/provide, and the base station 504 may be configured to receive, a HARQ-ACK (e.g., 610 in FIG. 6) based on reception of the set of data structure indices (e.g., 620 in FIG. 6). At 1404, the network node receives, from the UE and based on the set of measurement configurations, a capability indication indicative of at least one of (i) a parameter selection capability of the UE associated with mobility measurement parameters based on the AI/ML model or (ii) a data collection capability of the UE associated with at least one of a number or a list of mobility measurement values of the set of mobility measurement values that have been selected since a last data collection report. As an example, the reception may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) receiving such a capability indication from a UE (e.g., the UE 502).

To receive the set of measurement configurations, the UE 502 may be configured to report (e.g., transmit/provide), and the base station 504 may be configured to receive, based on the set of measurement configurations 506 (e.g., 606 in FIG. 6; 706 in FIG. 7; 806 in FIG. 8), a capability indication (e.g., 605 in FIG. 6) indicative of at least one of (i) a parameter selection capability (e.g., 622 in FIG. 6) of the UE associated with mobility measurement parameters (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) based on the AI/ML model 550 (e.g., 650 in FIG. 6; 750 in FIG. 7; 850 in FIG. 8) or (ii) a data collection capability (e.g., 624 in FIG. 6) of the UE associated with at least one of a number or a list of mobility measurement values (e.g., 722 in FIG. 7) of the set of mobility measurement values (e.g., 760 in FIG. 7) that have been selected since a last selected value report (e.g., 810 in FIG. 8) and/or a last data collection report (e.g., a most recent instance of a transmission for the selected value report 512 (e.g., 810 in FIG. 8)/a data collection report, as described for FIG. 7). In aspects, the UE 502 may be configured to obtain (at 508) a set of mobility measurements associated with a set of network nodes. The set of network nodes may include a serving cell (e.g., a network node such as the base station 504, a gNB, etc.) and at least one neighboring cell (e.g., at least one network node such as the base station 505, a gNB, etc.) (e.g., 803, 805 in FIG. 8). In aspects, the UE 502 may be configured with the set of mobility measurements associated with the set of network nodes by one or more of the set of network nodes. The UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10), associated with a set of mobility parameter ranges (e.g., 616 in FIG. 6), in accordance with an artificial intelligence AI/ML model 550 (e.g., 650 in FIG. 6; 750 in FIG. 7; 850 in FIG. 8) and based on at least one of the set of mobility measurements or the set of measurement configurations 506 (e.g., 606 in FIG. 6; 706 in FIG. 7; 806 in FIG. 8) indicative of at least one of a set of mobility measurement parameter candidates (e.g., 762 in FIG. 7) or the set of mobility parameter ranges (e.g., 616 in FIG. 6). In aspects, the UE 502 may be configured to select (at 510) at least one second mobility measurement parameter of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) that is different from at least one of the set of mobility measurement parameter candidates (e.g., based on an override by the UE 502) (e.g., 762 in FIG. 7) or the set of mobility parameter ranges (e.g., 616 in FIG. 6). In aspects, the UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) in accordance with the set of measurement configurations 506 (e.g., 606 in FIG. 6; 706 in FIG. 7; 806 in FIG. 8) indicative of at least one of the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) or the set of mobility parameter ranges (e.g., 616 in FIG. 6). In aspects, the UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) in accordance with a selection indication included in the set of measurement configurations 506 (e.g., 606 in FIG. 6; 706 in FIG. 7; 806 in FIG. 8). In aspects, the UE 502 may be configured to select (at 510) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) as including to measure (e.g., at 809 in FIG. 8) the set of mobility measurement values (e.g., 760 in FIG. 7) in accordance with the set of measurement configurations 506 (e.g., 606 in FIG. 6; 706 in FIG. 7; 806 in FIG. 8) being indicative of the set of mobility measurement values (e.g., 760 in FIG. 7) for the measurements (e.g., at 809 in FIG. 8). At 1406, the network node receives, from the UE and at a time in accordance with an AI/ML model associated with mobility measurements, a selected value report indicative of a set of mobility measurement values associated with a set of mobility measurement parameters. As an example, the reception may be performed by one or more of the component 199, the transceiver(s) 1646, and/or the antenna 1680 in FIG. 16. FIG. 5 illustrates, in the context of FIGS. 6, 7, 8, 9, 10, an example of a network node (e.g., the base station 504) receiving such a selected value report from a UE (e.g., the UE 502).

The UE 502 may be configured to transmit/provide, to the serving cell (e.g., the base station 504 which may be configured to receive), at a time in accordance with the AI/ML model 550 (e.g., 650 in FIG. 6; 750 in FIG. 7; 850 in FIG. 8), a selected value report (SVR) 512 (e.g., 810 in FIG. 8). The selected value report 512 (e.g., 810 in FIG. 8) may be indicative of a set of mobility measurement values (e.g., 760 in FIG. 7) associated with the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). In aspects, the UE 502 may be configured to transmit the selected value report 512 (e.g., 810 in FIG. 8) in accordance with the set of measurement configurations 506 (e.g., 606 in FIG. 6; 706 in FIG. 7; 806 in FIG. 8). The set of measurement configurations 506 (e.g., 606 in FIG. 6; 706 in FIG. 7; 806 in FIG. 8) may be indicative of at least one of periodic transmission (e.g., 732 in FIG. 7) or event triggered transmission (e.g., 734 in FIG. 7) of the selected value report 512 (e.g., 810 in FIG. 8). The UE 502 may be configured to transmit/provide the selected value report 512 (e.g., 810 in FIG. 8) based on a prohibit timer (e.g., 730 in FIG. 7; 818 in FIG. 8) that is indicative of a time period during which the transmission of the selected value report (e.g., 810 in FIG. 8) is prohibited.

In aspects, the UE 502 may be configured to fall back to indications/settings/values of the set of measurement configurations 506 (e.g., 606 in FIG. 6; 706 in FIG. 7; 806 in FIG. 8), e.g., based on worsening performance associated with overrides/recommendations selected (e.g., at 510) for the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10). The UE 502 may be configured to revert (e.g., 826 in FIG. 8) to a set of candidate mobility measurement values (e.g., 760 in FIG. 7), associated with the serving cell (e.g., the base station 504), for the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) based on a radio link failure or a handover failure (e.g., 824 in FIG. 8), in some aspects. In aspects, based on the reversion (e.g., 826 in FIG. 8) and/or the failure (e.g., 824 in FIG. 8), a prohibit timer (e.g., 828 in FIG. 8) may be activated during which the UE 502 may not be allowed/enabled to use a set of mobility measurement parameters selected by the UE 502. Additionally, the UE 502 may be configured to reselect (e.g., at 834 in FIG. 8) the set of mobility measurement parameters 511 (e.g., 709 in FIG. 7; 902, 904, 906, 908, 910, 912, 920, 922 in FIG. 9; 1002, 1004, 1006, 1008, 1010, 1012, 1014, 1016, 1018, 1020, 1022, 1024 in FIG. 10) in accordance with the AI/ML model 550 (e.g., 650 in FIG. 6; 750 in FIG. 7; 850 in FIG. 8) based on an expiration (e.g., 832 in FIG. 8) of a prohibit timer (e.g., 828 in FIG. 8) associated with a reversion to the set of candidate mobility measurement values (e.g., 760 in FIG. 7), in some aspects.

FIG. 15 is a diagram 1500 illustrating an example of a hardware implementation for an apparatus 1504. The apparatus 1504 may be a UE, a component of a UE, or may implement UE functionality. In some aspects, the apparatus 1504 may include at least one cellular baseband processor 1524 (also referred to as a modem) coupled to one or more transceivers 1522 (e.g., cellular RF transceiver). The cellular baseband processor(s) 1524 may include at least one on-chip memory 1524′. In some aspects, the apparatus 1504 may further include one or more subscriber identity modules (SIM) cards 1520 and at least one application processor 1506 coupled to a secure digital (SD) card 1508 and a screen 1510. The application processor(s) 1506 may include on-chip memory 1506′. In some aspects, the apparatus 1504 may further include a Bluetooth module 1512, a WLAN module 1514, an SPS module 1516 (e.g., GNSS module), one or more sensor modules 1518 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1526, a power supply 1530, and/or a camera 1532. The Bluetooth module 1512, the WLAN module 1514, and the SPS module 1516 may include an on-chip transceiver (TRX) (or in some cases, just a receiver (RX)). The Bluetooth module 1512, the WLAN module 1514, and the SPS module 1516 may include their own dedicated antennas and/or utilize the antennas 1580 for communication. The cellular baseband processor(s) 1524 communicates through the transceiver(s) 1522 via one or more antennas 1580 with the UE 104 and/or with an RU associated with a network entity 1502. The cellular baseband processor(s) 1524 and the application processor(s) 1506 may each include a computer-readable medium/memory 1524′, 1506′, respectively. The additional memory modules 1526 may also be considered a computer-readable medium/memory. Each computer-readable medium/memory 1524′, 1506′, 1526 may be non-transitory. The cellular baseband processor(s) 1524 and the application processor(s) 1506 are each responsible for general processing, including the execution of software stored on the computer-readable medium/memory. The software, when executed by the cellular baseband processor(s) 1524/application processor(s) 1506, causes the cellular baseband processor(s) 1524/application processor(s) 1506 to perform the various functions described supra. The cellular baseband processor(s) 1524 and the application processor(s) 1506 are configured to perform the various functions described supra based at least in part of the information stored in the memory. That is, the cellular baseband processor(s) 1524 and the application processor(s) 1506 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 1524/application processor(s) 1506 when executing software. The cellular baseband processor(s) 1524/application processor(s) 1506 may be a component of the UE 350 and may include the at least one memory 360 and/or at least one of the TX processor 368, the RX processor 356, and the controller/processor 359. In one configuration, the apparatus 1504 may be at least one processor chip (modem and/or application) and include just the cellular baseband processor(s) 1524 and/or the application processor(s) 1506, and in another configuration, the apparatus 1504 may be the entire UE (e.g., see UE 350 of FIG. 3) and include the additional modules of the apparatus 1504.

As discussed supra, the component 198 may be configured to obtain a set of mobility measurements associated with a set of network nodes, where the set of network nodes includes a serving cell and at least one neighboring cell. The component 198 may be configured to select a set of mobility measurement parameters, associated with a set of mobility parameter ranges, in accordance with an AI/ML model and based on at least one of the set of mobility measurements or a set of measurement configurations indicative of at least one of a set of mobility measurement parameter candidates or the set of mobility parameter ranges. The component 198 may be configured to transmit, to the serving cell and at a time in accordance with the AI/ML model, a selected value report indicative of a set of mobility measurement values associated with the set of mobility measurement parameters. The component 198 may be configured to receive, from the serving cell via at least one of first RRC signaling, a MAC-CE, or first DCI, the set of measurement configurations indicative of at least one of the set of mobility measurement parameters or the set of mobility parameter ranges. The component 198 may be configured to revert to a set of candidate mobility measurement values, associated with the serving cell, for the set of mobility measurement parameters based on a radio link failure or a handover failure. The component 198 may be configured to reselect the set of mobility measurement parameters in accordance with the AI/ML model based on an expiration of a prohibit timer associated with reverting to the set of candidate mobility measurement values. The component 198 may be further configured to perform any of the aspects described in connection with the flowcharts in any of FIGS. 11, 12, 13, 14 and/or any of the aspects performed by a UE for any of FIGS. 4-10. The component 198 may be within the cellular baseband processor(s) 1524, the application processor(s) 1506, or both the cellular baseband processor(s) 1524 and the application processor(s) 1506. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1504 may include a variety of components configured for various functions. In one configuration, the apparatus 1504, and in particular the cellular baseband processor(s) 1524 and/or the application processor(s) 1506, may include means for obtaining a set of mobility measurements associated with a set of network nodes, where the set of network nodes includes a serving cell and at least one neighboring cell. In one configuration, the apparatus 1504, and in particular the cellular baseband processor(s) 1524 and/or the application processor(s) 1506, may include means for selecting a set of mobility measurement parameters, associated with a set of mobility parameter ranges, in accordance with an AI/ML model and based on at least one of the set of mobility measurements or a set of measurement configurations indicative of at least one of a set of mobility measurement parameter candidates or the set of mobility parameter ranges. In one configuration, the apparatus 1504, and in particular the cellular baseband processor(s) 1524 and/or the application processor(s) 1506, may include means for transmitting, to the serving cell and at a time in accordance with the AI/ML model, a selected value report indicative of a set of mobility measurement values associated with the set of mobility measurement parameters. In one configuration, the apparatus 1504, and in particular the cellular baseband processor(s) 1524 and/or the application processor(s) 1506, may include means for receiving, from the serving cell via at least one of first RRC signaling, a MAC-CE, or first DCI, the set of measurement configurations indicative of at least one of the set of mobility measurement parameters or the set of mobility parameter ranges. In one configuration, the apparatus 1504, and in particular the cellular baseband processor(s) 1524 and/or the application processor(s) 1506, may include means for reverting to a set of candidate mobility measurement values, associated with the serving cell, for the set of mobility measurement parameters based on a radio link failure or a handover failure. In one configuration, the apparatus 1504, and in particular the cellular baseband processor(s) 1524 and/or the application processor(s) 1506, may include means for reselecting the set of mobility measurement parameters in accordance with the AI/ML model based on an expiration of a prohibit timer associated with reverting to the set of candidate mobility measurement values. The means may be the component 198 of the apparatus 1504 configured to perform the functions recited by the means. As described supra, the apparatus 1504 may include the TX processor 368, the RX processor 356, and the controller/processor 359. As such, in one configuration, the means may be the TX processor 368, the RX processor 356, and/or the controller/processor 359 configured to perform the functions recited by the means.

FIG. 16 is a diagram 1600 illustrating an example of a hardware implementation for a network entity 1602. The network entity 1602 may be a BS, a component of a BS, or may implement BS functionality. The network entity 1602 may include at least one of a CU 1610, a DU 1630, or an RU 1640. For example, depending on the layer functionality handled by the component 199, the network entity 1602 may include the CU 1610; both the CU 1610 and the DU 1630; each of the CU 1610, the DU 1630, and the RU 1640; the DU 1630; both the DU 1630 and the RU 1640; or the RU 1640. The CU 1610 may include at least one CU processor 1612. The CU processor(s) 1612 may include on-chip memory 1612′. In some aspects, the CU 1610 may further include additional memory modules 1614 and a communications interface 1618. The CU 1610 communicates with the DU 1630 through a midhaul link, such as an F1 interface. The DU 1630 may include at least one DU processor 1632. The DU processor(s) 1632 may include on-chip memory 1632′. In some aspects, the DU 1630 may further include additional memory modules 1634 and a communications interface 1638. The DU 1630 communicates with the RU 1640 through a fronthaul link. The RU 1640 may include at least one RU processor 1642. The RU processor(s) 1642 may include on-chip memory 1642′. In some aspects, the RU 1640 may further include additional memory modules 1644, one or more transceivers 1646, antennas 1680, and a communications interface 1648. The RU 1640 communicates with the UE 104. The on-chip memory 1612′, 1632′, 1642′ and the additional memory modules 1614, 1634, 1644 may each be considered a computer-readable medium/memory. Each computer-readable medium/memory may be non-transitory. Each of the processors 1612, 1632, 1642 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the component 199 may be configured to transmit, for a UE, a set of measurement configurations indicative of at least one of a set of mobility measurement parameter candidates or a set of mobility parameter ranges. The component 199 may be configured to receive, from the UE and at a time in accordance with an AI/ML model associated with mobility measurements, a selected value report indicative of a set of mobility measurement values associated with a set of mobility measurement parameters. The component 199 may be configured to receive, from the UE and at a time in accordance with an AI/ML model associated with mobility measurements, a selected value report indicative of a set of mobility measurement values associated with a set of mobility measurement parameters. The component 199 may be further configured to perform any of the aspects described in connection with the flowcharts in any of FIGS. 11, 12, 13, 14 and/or any of the aspects performed by a network node as a serving cell (e.g., a base station, a gNB, a network entity, etc.) for any of FIGS. 4-10. The component 199 may be within one or more processors of one or more of the CU 1610, DU 1630, and the RU 1640. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1602 may include a variety of components configured for various functions. In one configuration, the network entity 1602 may include means for transmitting, for a UE, a set of measurement configurations indicative of at least one of a set of mobility measurement parameter candidates or a set of mobility parameter ranges. In one configuration, the network entity 1602 may include means for receiving, from the UE and at a time in accordance with an AI/ML model associated with mobility measurements, a selected value report indicative of a set of mobility measurement values associated with a set of mobility measurement parameters. In one configuration, the network entity 1602 may include means for receiving, from the UE and at a time in accordance with an AI/ML model associated with mobility measurements, a selected value report indicative of a set of mobility measurement values associated with a set of mobility measurement parameters. The means may be the component 199 of the network entity 1602 configured to perform the functions recited by the means. As described supra, the network entity 1602 may include the TX processor 316, the RX processor 370, and the controller/processor 375. As such, in one configuration, the means may be the TX processor 316, the RX processor 370, and/or the controller/processor 375 configured to perform the functions recited by the means.

UEs may be, may comprise, and/or may be paired with XR devices to provide user experiences through XR. Wireless communication networks, such as 5G NR, provide a high-speed, low-latency and high-reliability wireless connectivity which can enable latency-sensitive services like the immersive XR multimedia and cloud computing (e.g., AR Glasses, a VR HMD, cloud gaming, cloud AI, etc.). These advanced applications may have high levels for operational/system performance parameters to maintain the user experience, including but without limitation, data rate, latency, power consumption, and/or the like. As an example, to maintain low-latency and high-reliability, for an XR user experience, approximately 99% of packets for XR traffic should be delivered within a stipulated PDB (e.g., 10 ms). However, handover is a challenging issue for latency-sensitive services like XR, as it can increase the interruption times and latencies. The reception of selected value reports at the wireless network by a network node (e.g., by a base station, gNB, etc.) triggers the handover procedure, and thus, the configuration of these measurements and selected value reports is very impactful in maintaining a good user experience. A UE can be configured with mobility measurements on neighboring cells, and for each measurement configuration, the selected value report can be event triggered. In some cases, selected value reports may be controlled by RRC signaling parameters. Yet, the parameter settings impact the performance of the handover procedures. For instance, if the parameter settings are incorrectly set, the selected value report may not be transmitted at the right time. As one example, if the selected value report is sent too late, the selected value report may not be received by the network node, or the handover command may not be received by the UE, because the radio conditions worsened (e.g., resulting in radio link failure). As another example, if the selected value report is sent too early, the UE may be moved to the target cell too early, and the user experience may have been better had the UE stayed longer in the source cell, or even less desirably, the UE may not be able to connect to the target cell (e.g., resulting in handover failure). Current solutions for parameter settings and triggering selected value reports via semi-static settings lack robustness to accommodate radio-related situations for UEs, and may negatively impact the user experience for XR applications.

Aspects herein for AI native mobility measurement parameters selection improve the quality of a user experience in XR through increased robustness for radio-related situations for UEs. Aspects enable a UE to perform mobility measurement parameter selection(s) based on an AI/ML model within a configuration range allowed by the network, enable a network node to configure the UE for parameters, ranges, overrides, and/or reporting of values, and enable the network node to dynamically update parameter values for the UE. Aspects provide for UE configurations for data collection and reporting, such as for each measurement configuration, and for UE fallback to network configured values based on performance. Aspects accommodate timing of radio-related situations for UEs to prevent radio link failure and handover failure by enabling AI/ML selection/triggers of selected parameter values. Aspects refine and improve parameter value selection and implementation in wireless networks by enabling UE data collection and report of data and measurement values. Aspects also improve parameter value selection and implementation based on a UE perspective by enabling UE overrides of configured selected parameter values and value recommendations.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method for wireless communication at a user equipment (UE), comprising: at least one memory; and at least one processor coupled to the at least one memory and, based at least in part on information stored in the at least one memory, the at least one processor, individually or in any combination, is configured to: obtain a set of mobility measurements associated with a set of network nodes, wherein the set of network nodes includes a serving cell and at least one neighboring cell; select a set of mobility measurement parameters, associated with a set of mobility parameter ranges, in accordance with an artificial intelligence (AI)/machine learning (ML) (AI/ML) model and based on at least one of the set of mobility measurements or a set of measurement configurations indicative of at least one of a set of mobility measurement parameter candidates or the set of mobility parameter ranges; and transmit, to the serving cell and at a time in accordance with the AI/ML model, a selected value report indicative of a set of mobility measurement values associated with the set of mobility measurement parameters.

Aspect 2 is the method of aspect 1, further comprising at least one transceiver coupled to the at least one processor, wherein the at least one processor, individually or in any combination, is further configured to: receive, from the serving cell via the at least one transceiver and via at least one of first radio resource control (RRC) signaling, a first medium access control (MAC) control element (MAC-CE), or first downlink control information (DCI), the set of measurement configurations indicative of at least one of the set of mobility measurement parameters or the set of mobility parameter ranges.

Aspect 3 is the method of aspect 2, wherein to receive the set of measurement configurations, the at least one processor, individually or in any combination, is configured to receive a set of dynamic measurement configuration updates associated with at least one of the set of mobility measurement parameters or the set of mobility parameter ranges.

Aspect 4 is the method of aspect 3, wherein to receive the set of dynamic measurement configuration updates, the at least one processor, individually or in any combination, is configured to: receive, via second RRC signaling, a data structure indicative of a set of candidate mobility measurement values associated with at least one of the set of mobility measurement parameters or the set of mobility parameter ranges; receive, via at least one of a second MAC-CE or second DCI, a set of data structure indices associated with the data structure indicative of the set of candidate mobility measurement values; and transmit, to the serving cell, a hybrid automatic repeat request (HARQ) acknowledgement (HARQ-ACK) based on reception of the set of data structure indices.

Aspect 5 is the method of aspect 2, wherein to receive the set of measurement configurations, the at least one processor, individually or in any combination, is configured to: report, to the serving cell and based on the set of measurement configurations, a capability indication indicative of at least one of (i) a parameter selection capability of the UE associated with mobility measurement parameters based on the AI/ML model or (ii) a data collection capability of the UE associated with at least one of a number or a list of mobility measurement values of the set of mobility measurement values that have been selected since a last selected value report.

Aspect 6 is the method of any of aspects 1 to 5, wherein to select the set of mobility measurement parameters, the at least one processor, individually or in any combination, is configured to select at least one second mobility measurement parameter of the set of mobility measurement parameters that is different from at least one of the set of mobility measurement parameter candidates or the set of mobility parameter ranges.

Aspect 7 is the method of any of aspects 1 to 6, wherein to select the set of mobility measurement parameters, the at least one processor, individually or in any combination, is configured to select the set of mobility measurement parameters in accordance with the set of measurement configurations indicative of at least one of the set of mobility measurement parameters or the set of mobility parameter ranges.

Aspect 8 is the method of any of aspects 1 to 7, wherein to select the set of mobility measurement parameters, the at least one processor, individually or in any combination, is configured to select the set of mobility measurement parameters in accordance with a selection indication included in the set of measurement configurations.

Aspect 9 is the method of any of aspects 1 to 8, wherein the set of measurement configurations is indicative of at least one of a minimum value, a maximum value, or a set of candidate values for one or more of the set of mobility measurement parameters.

Aspect 10 is the method of any of aspects 1 to 9, wherein the set of measurement configurations is indicative of at least one enabled override by the UE for one or more of the set of mobility measurement parameters.

Aspect 11 is the method of any of aspects 1 to 10, wherein the set of measurement configurations is indicative of transmission for the selected value report via at least one of radio resource control (RRC) signaling, a medium access control (MAC) control element (MAC-CE), or uplink control information (UCI); wherein to transmit the selected value report, the at least one processor, individually or in any combination, is configured to transmit the selected value report in accordance with the set of measurement configurations, wherein the set of measurement configurations is indicative of at least one of periodic transmission or event triggered transmission of the selected value report.

Aspect 12 is the method of aspect 11, wherein the RRC signaling includes at least one of UE assistance information (UAI) or a separate measurement message.

Aspect 13 is the method of aspect 11, wherein to transmit the selected value report, the at least one processor, individually or in any combination, is configured to transmit the selected value report based on a prohibit timer that is indicative of a time period during which the transmission of the selected value report is prohibited.

Aspect 14 is the method of any of aspects 1 to 13, wherein the set of measurement configurations is indicative of the set of mobility measurement values for measurements; wherein to select the set of mobility measurement parameters, the at least one processor, individually or in any combination, is configured to measure the set of mobility measurement values in accordance with the set of measurement configurations being indicative of the set of mobility measurement values for the measurements.

Aspect 15 is the method of aspect 14, wherein the set of measurement configurations is further indicative of at least one of a number or a list of mobility measurement values of the set of mobility measurement values that have been selected since a last data collection report; or wherein the set of measurement configurations is further indicative of at least one of a transmission periodicity, a transmission event trigger, or a prohibit timer associated with a data collection report.

Aspect 16 is the method of any of aspects 1 to 15, wherein the at least one processor, individually or in any combination, is further configured to: revert to a set of candidate mobility measurement values, associated with the serving cell, for the set of mobility measurement parameters based on a radio link failure or a handover failure; or reselect the set of mobility measurement parameters in accordance with the AI/ML model based on an expiration of a prohibit timer associated with reverting to the set of candidate mobility measurement values.

Aspect 17 is a method for wireless communication at a network node, comprising: at least one memory; and at least one processor coupled to the at least one memory and, based at least in part on information stored in the at least one memory, the at least one processor, individually or in any combination, is configured to: transmit, for a user equipment (UE), a set of measurement configurations indicative of at least one of a set of mobility measurement parameter candidates or a set of mobility parameter ranges; and receive, from the UE and at a time in accordance with an artificial intelligence (AI)/machine learning (ML) (AI/ML) model associated with mobility measurements, a selected value report indicative of a set of mobility measurement values associated with a set of mobility measurement parameters.

Aspect 18 is the method of aspect 17, wherein to transmit, for the UE, the set of measurement configurations indicative of at least one of the set of mobility measurement parameter candidates or the set of mobility parameter ranges, the at least one processor, individually or in any combination, is configured to transmit, for the UE via at least one of first radio resource control (RRC) signaling, a first medium access control (MAC) control element (MAC-CE), or first downlink control information (DCI), the set of measurement configurations.

Aspect 19 is the method of aspect 18, wherein to transmit, for the UE, the set of measurement configurations, the at least one processor, individually or in any combination, is configured to transmit, for the UE, a set of dynamic measurement configuration updates associated with at least one of the set of mobility measurement parameter candidates or the set of mobility parameter ranges.

Aspect 20 is the method of aspect 19, wherein to transmit, for the UE, the set of measurement configurations, the at least one processor, individually or in any combination, is configured to: transmit, via second RRC signaling, a data structure indicative of a set of candidate mobility measurement values associated with at least one of the set of mobility measurement parameter candidates or the set of mobility parameter ranges; transmit, via at least one of a second MAC-CE or second DCI, a set of data structure indices associated with the data structure indicative of the set of candidate mobility measurement values; and receive, from the UE, a hybrid automatic repeat request (HARQ) acknowledgement (HARQ-ACK) based on transmission of the set of data structure indices.

Aspect 21 is the method of aspect 18, further comprising at least one transceiver coupled to the at least one processor, wherein the at least one processor, individually or in any combination, is further configured to: receive, from the UE via the at least one transceiver and based on the set of measurement configurations, a capability indication indicative of at least one of (i) a parameter selection capability of the UE associated with mobility measurement parameters based on the AI/ML model or (ii) a data collection capability of the UE associated with at least one of a number or a list of mobility measurement values of the set of mobility measurement values that have been selected since a last selected value report.

Aspect 22 is the method of any of aspects 17 to 21, wherein the set of mobility measurement parameters includes at least one second mobility measure parameter that is different from at least one of the set of mobility measurement parameter candidates and within the set of mobility parameter ranges; or wherein the set of mobility measurement parameters includes the set of mobility measurement parameter candidates in accordance with the set of measurement configurations.

Aspect 23 is the method of any of aspects 17 to 22, wherein the set of mobility measurement parameters includes mobility measurement parameters in accordance with a selection indication included in the set of measurement configurations.

Aspect 24 is the method of any of aspects 17 to 23, wherein the set of measurement configurations is indicative of at least one of a minimum value, a maximum value, or a set of candidate values for one or more of the set of mobility measurement parameter candidates; or wherein the set of measurement configurations is indicative of at least one enabled override for the UE of one or more of the set of mobility measurement parameter candidates.

Aspect 25 is the method of any of aspects 17 to 24, wherein the set of measurement configurations is indicative of transmission for the selected value report via at least one of radio resource control (RRC) signaling, a medium access control (MAC) control element (MAC-CE), or uplink control information (UCI); wherein to receive the selected value report, the at least one processor, individually or in any combination, is configured to receive the selected value report in accordance with the set of measurement configurations, wherein the set of measurement configurations is indicative of at least one of periodic transmission or event triggered transmission of the selected value report.

Aspect 26 is the method of aspect 25, wherein the RRC signaling includes at least one of UE assistance information (UAI) or a separate measurement message; or wherein to receive the selected value report, the at least one processor, individually or in any combination, is configured to receive the selected value report based on a prohibit timer that is indicative of a time period during which the transmission of the selected value report is prohibited.

Aspect 27 is the method of any of aspects 17 to 26, wherein the set of measurement configurations is indicative of the set of mobility measurement values for measurements; wherein the set of mobility measurement values is based on the measurements in accordance with the set of measurement configurations.

Aspect 28 is the method of aspect 27, wherein the set of measurement configurations is further indicative of at least one of a number or a list of mobility measurement values of the set of mobility measurement values that have been selected since a last selected value report; or wherein the set of measurement configurations is further indicative of at least one of a transmission periodicity, a transmission event trigger, or a prohibit timer associated with the selected value report.

Aspect 29 is an apparatus for wireless communication at a user equipment (UE), comprising: at least one memory; and at least one processor coupled to the at least one memory, the at least one processor, individually or in any combination, is configured to perform the method of any of aspects 1 to 16.

Aspect 30 is an apparatus for wireless communication at a user equipment (UE), comprising means for performing each step in the method of any of aspects 1 to 16.

Aspect 31 is the apparatus of any of aspects 29 to 30, further comprising a transceiver configured to receive or to transmit in association with the method of any of aspects 1 to 16.

Aspect 32 is a computer-readable medium (e.g., a non-transitory computer-readable medium) storing computer executable code at a user equipment (UE), the code when executed by at least one processor causes the at least one processor to perform the method of any of aspects 1 to 16.

Aspect 33 is an apparatus for wireless communication at a network node, comprising: at least one memory; and at least one processor coupled to the at least one memory, the at least one processor, individually or in any combination, is configured to perform the method of any of aspects 17 to 28.

Aspect 34 is an apparatus for wireless communication at a network node, comprising means for performing each step in the method of any of aspects 17 to 28.

Aspect 35 is the apparatus of any of aspects 29 to 30, further comprising a transceiver configured to receive or to transmit in association with the method of any of aspects 17 to 28.

Aspect 36 is a computer-readable medium (e.g., a non-transitory computer-readable medium) storing computer executable code at a network node, the code when executed by at least one processor causes the at least one processor to perform the method of any of aspects 17 to 28.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to:
obtain a set of mobility measurements associated with a set of network nodes, wherein the set of network nodes includes a serving cell and at least one neighboring cell;
select a set of mobility measurement parameters, associated with a set of mobility parameter ranges, in accordance with an artificial intelligence (AI)/machine learning (ML) (AI/ML) model and based on at least one of the set of mobility measurements or a set of measurement configurations indicative of at least one of a set of mobility measurement parameter candidates or the set of mobility parameter ranges; and
transmit, to the serving cell and at a time in accordance with the AI/ML model, a selected value report indicative of a set of mobility measurement values associated with the set of mobility measurement parameters.

2. The apparatus of claim 1, further comprising at least one transceiver coupled to the at least one processor, wherein the at least one processor, individually or in any combination, is further configured to:
receive, from the serving cell via the at least one transceiver and via at least one of first radio resource control (RRC) signaling, a first medium access control (MAC) control element (MAC-CE), or first downlink control information (DCI), the set of measurement configurations indicative of at least one of the set of mobility measurement parameters or the set of mobility parameter ranges.

3. The apparatus of claim 2, wherein to receive the set of measurement configurations, the at least one processor, individually or in any combination, is configured to receive a set of dynamic measurement configuration updates associated with at least one of the set of mobility measurement parameters or the set of mobility parameter ranges.

4. The apparatus of claim 3, wherein to receive the set of dynamic measurement configuration updates, the at least one processor, individually or in any combination, is configured to:
receive, via second RRC signaling, a data structure indicative of a set of candidate mobility measurement values associated with at least one of the set of mobility measurement parameters or the set of mobility parameter ranges;
receive, via at least one of a second MAC-CE or second DCI, a set of data structure indices associated with the data structure indicative of the set of candidate mobility measurement values; and
transmit, to the serving cell, a hybrid automatic repeat request (HARQ) acknowledgement (HARQ-ACK) based on reception of the set of data structure indices.

5. The apparatus of claim 2, wherein to receive the set of measurement configurations, the at least one processor, individually or in any combination, is configured to:
report, to the serving cell and based on the set of measurement configurations, a capability indication indicative of at least one of (i) a parameter selection capability of the UE associated with mobility measurement parameters based on the AI/ML model or (ii) a data collection capability of the UE associated with at least one of a number or a list of mobility measurement values of the set of mobility measurement values that have been selected since a last selected value report.

6. The apparatus of claim 1, wherein to select the set of mobility measurement parameters, the at least one processor, individually or in any combination, is configured to select at least one second mobility measurement parameter of the set of mobility measurement parameters that is different from at least one of the set of mobility measurement parameter candidates or the set of mobility parameter ranges.

7. The apparatus of claim 1, wherein to select the set of mobility measurement parameters, the at least one processor, individually or in any combination, is configured to select the set of mobility measurement parameters in accordance with the set of measurement configurations indicative of at least one of the set of mobility measurement parameters or the set of mobility parameter ranges.

8. The apparatus of claim 1, wherein to select the set of mobility measurement parameters, the at least one processor, individually or in any combination, is configured to select the set of mobility measurement parameters in accordance with a selection indication included in the set of measurement configurations.

9. The apparatus of claim 1, wherein the set of measurement configurations is indicative of at least one of a minimum value, a maximum value, or a set of candidate values for one or more of the set of mobility measurement parameters.

10. The apparatus of claim 1, wherein the set of measurement configurations is indicative of at least one enabled override by the UE for one or more of the set of mobility measurement parameters.

11. The apparatus of claim 1, wherein the set of measurement configurations is indicative of transmission for the selected value report via at least one of radio resource control (RRC) signaling, a medium access control (MAC) control element (MAC-CE), or uplink control information (UCI);
wherein to transmit the selected value report, the at least one processor, individually or in any combination, is configured to transmit the selected value report in accordance with the set of measurement configurations, wherein the set of measurement configurations is indicative of at least one of periodic transmission or event triggered transmission of the selected value report.

12. The apparatus of claim 11, wherein the RRC signaling includes at least one of UE assistance information (UAI) or a separate measurement message.

13. The apparatus of claim 11, wherein to transmit the selected value report, the at least one processor, individually or in any combination, is configured to transmit the selected value report based on a prohibit timer that is indicative of a time period during which the transmission of the selected value report is prohibited.

14. The apparatus of claim 1, wherein the set of measurement configurations is indicative of the set of mobility measurement values for measurements;
wherein to select the set of mobility measurement parameters, the at least one processor, individually or in any combination, is configured to measure the set of mobility measurement values in accordance with the set of measurement configurations being indicative of the set of mobility measurement values for the measurements.

15. The apparatus of claim 14, wherein the set of measurement configurations is further indicative of at least one of a number or a list of mobility measurement values of the set of mobility measurement values that have been selected since a last data collection report; or
wherein the set of measurement configurations is further indicative of at least one of a transmission periodicity, a transmission event trigger, or a prohibit timer associated with a data collection report.

16. The apparatus of claim 1, wherein the at least one processor, individually or in any combination, is further configured to:
revert to a set of candidate mobility measurement values, associated with the serving cell, for the set of mobility measurement parameters based on a radio link failure or a handover failure; or
reselect the set of mobility measurement parameters in accordance with the AI/ML model based on an expiration of a prohibit timer associated with reverting to the set of candidate mobility measurement values.

17. An apparatus for wireless communication at a network node, comprising:
at least one memory; and
at least one processor coupled to the at least one memory and, based at least in part on information stored in the at least one memory, the at least one processor, individually or in any combination, is configured to:
transmit, for a user equipment (UE), a set of measurement configurations indicative of at least one of a set of mobility measurement parameter candidates or a set of mobility parameter ranges; and
receive, from the UE and at a time in accordance with an artificial intelligence (AI)/machine learning (ML) (AI/ML) model associated with mobility measurements, a selected value report indicative of a set of mobility measurement values associated with a set of mobility measurement parameters.

18. The apparatus of claim 17, wherein to transmit, for the UE, the set of measurement configurations indicative of at least one of the set of mobility measurement parameter candidates or the set of mobility parameter ranges, the at least one processor, individually or in any combination, is configured to transmit, for the UE via at least one of first radio resource control (RRC) signaling, a first medium access control (MAC) control element (MAC-CE), or first downlink control information (DCI), the set of measurement configurations.

19. The apparatus of claim 18, wherein to transmit, for the UE, the set of measurement configurations, the at least one processor, individually or in any combination, is configured to transmit, for the UE, a set of dynamic measurement configuration updates associated with at least one of the set of mobility measurement parameter candidates or the set of mobility parameter ranges.

20. The apparatus of claim 19, wherein to transmit, for the UE, the set of measurement configurations, the at least one processor, individually or in any combination, is configured to:
transmit, via second RRC signaling, a data structure indicative of a set of candidate mobility measurement values associated with at least one of the set of mobility measurement parameter candidates or the set of mobility parameter ranges;
transmit, via at least one of a second MAC-CE or second DCI, a set of data structure indices associated with the data structure indicative of the set of candidate mobility measurement values; and
receive, from the UE, a hybrid automatic repeat request (HARQ) acknowledgement (HARQ-ACK) based on transmission of the set of data structure indices.

21. The apparatus of claim 18, further comprising at least one transceiver coupled to the at least one processor, wherein the at least one processor, individually or in any combination, is further configured to:
receive, from the UE via the at least one transceiver and based on the set of measurement configurations, a capability indication indicative of at least one of (i) a parameter selection capability of the UE associated with mobility measurement parameters based on the AI/ML model or (ii) a data collection capability of the UE associated with at least one of a number or a list of mobility measurement values of the set of mobility measurement values that have been selected since a last selected value report.

22. The apparatus of claim 17, wherein the set of mobility measurement parameters includes at least one second mobility measure parameter that is different from at least one of the set of mobility measurement parameter candidates and within the set of mobility parameter ranges; or
wherein the set of mobility measurement parameters includes the set of mobility measurement parameter candidates in accordance with the set of measurement configurations.

23. The apparatus of claim 17, wherein the set of mobility measurement parameters includes mobility measurement parameters in accordance with a selection indication included in the set of measurement configurations.

24. The apparatus of claim 17, wherein the set of measurement configurations is indicative of at least one of a minimum value, a maximum value, or a set of candidate values for one or more of the set of mobility measurement parameter candidates; or
wherein the set of measurement configurations is indicative of at least one enabled override for the UE of one or more of the set of mobility measurement parameter candidates.

25. The apparatus of claim 17, wherein the set of measurement configurations is indicative of transmission for the selected value report via at least one of radio resource control (RRC) signaling, a medium access control (MAC) control element (MAC-CE), or uplink control information (UCI);
wherein to receive the selected value report, the at least one processor, individually or in any combination, is configured to receive the selected value report in accordance with the set of measurement configurations, wherein the set of measurement configurations is indicative of at least one of periodic transmission or event triggered transmission of the selected value report.

26. The apparatus of claim 25, wherein the RRC signaling includes at least one of UE assistance information (UAI) or a separate measurement message; or
wherein to receive the selected value report, the at least one processor, individually or in any combination, is configured to receive the selected value report based on a prohibit timer that is indicative of a time period during which the transmission of the selected value report is prohibited.

27. The apparatus of claim 17, wherein the set of measurement configurations is indicative of the set of mobility measurement values for measurements;
wherein the set of mobility measurement values is based on the measurements in accordance with the set of measurement configurations.

28. The apparatus of claim 27, wherein the set of measurement configurations is further indicative of at least one of a number or a list of mobility measurement values of the set of mobility measurement values that have been selected since a last selected value report; or
wherein the set of measurement configurations is further indicative of at least one of a transmission periodicity, a transmission event trigger, or a prohibit timer associated with the selected value report.

29. A method of wireless communication at a user equipment (UE), comprising:
obtaining a set of mobility measurements associated with a set of network nodes, wherein the set of network nodes includes a serving cell and at least one neighboring cell;
selecting a set of mobility measurement parameters, associated with a set of mobility parameter ranges, in accordance with an artificial intelligence (AI)/machine learning (ML) (AI/ML) model and based on at least one of the set of mobility measurements or a set of measurement configurations indicative of at least one of a set of mobility measurement parameter candidates or the set of mobility parameter ranges; and
transmitting, to the serving cell and at a time in accordance with the AI/ML model, a selected value report indicative of a set of mobility measurement values associated with the set of mobility measurement parameters.

30. A method of wireless communication at a network node, comprising:
transmitting, for a user equipment (UE), a set of measurement configurations indicative of at least one of a set of mobility measurement parameter candidates or a set of mobility parameter ranges; and
receiving, from the UE and at a time in accordance with an artificial intelligence (AI)/machine learning (ML) (AI/ML) model associated with mobility measurements, a selected value report indicative of a set of mobility measurement values associated with a set of mobility measurement parameters.
